(19) United States
(12) Patent Application Publication
(10) Pub. No.: US 2025/0175292 A1
(43) Pub. Date: May 29, 2025

(54) RECEIVE TIMING DIFFERENCE REPORTING FOR MULTIPLE TRANSMISSION-RECEPTION POINT OPERATION

(71) Applicant: QUALCOMM Incorporated, San Diego, CA (US)

(72) Inventors: Fang YUAN, Beijing (CN); Changhwan PARK, San Diego, CA (US); Yan ZHOU, San Diego, CA (US); Jing SUN, San Diego, CA (US); Tao LUO, San Diego, CA (US)

(21) Appl. No.: 18/842,500

(22) PCT Filed: Apr. 28, 2022
(86) PCT No.: PCT/CN2022/089838

§ 371 Date: Aug. 29, 2024

(51) Int. Cl. H04L 5/00; H04B 7/0408; H04B 7/08

(52) U.S. Cl. CPC H04L 5/0035; H04B 7/0408; H04L 5/0053; H04B 7/0885

(57) ABSTRACT

Methods, systems, and devices for wireless communications are described. A user equipment (UE) may receive first signaling from a first TRP and second signaling from a second TRP. The UE may determine that a first receive timing difference between a first receive timing for the first signaling from the first TRP and a second receive timing for the second signaling from the second TRP exceeds a threshold. The UE may transmit, based on the determining, a first message indicating that the first receive timing difference between the first receive timing and the second receive timing exceeds the threshold. The UE may receive, in response to the first message, a second message indicating for the UE to perform wireless communications with a single TRP or with two TRPs associated with a second receive timing difference at the UE that is less than or equal to the threshold.

### CROSS REFERENCE

The present application is a 371 national phase filing of International PCT Application No. PCT/CN2022/089838 by YUAN et al., entitled “RECEIVE TIMING DIFFERENCE REPORTING FOR MULTIPLE TRANSMISSION-RECEPTION POINT OPERATION,” filed Apr. 28, 2022, which is assigned to the assignee hereof, and which is expressly incorporated by reference in its entirety herein.

### FIELD OF TECHNOLOGY

The following relates to wireless communications, including receive timing difference reporting for multiple transmission-reception point (TRP) operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support wireless communications via multiple transmission-reception points (multi TRPs).

### SUMMARY

The described techniques relate to improved methods, systems, devices, and apparatuses that support receive timing difference reporting for multiple transmission-reception point (TRP) operation. For example, the described techniques provide for determining, at a user equipment (UE), whether a receive timing difference associated with multiple TRPs exceeds a threshold. In some examples, the UE may receive first signaling from a first TRP and second signaling from a second TRP, the first TRP and the second TRP both associated with a network entity. The UE may determine that a first receive timing difference between a first receive timing for the first signaling from the first TRP and a second receive timing for the second signaling from the second TRP exceeds a threshold. The UE may transmit, to the network entity and based on the determining, a first message indicating that the first receive timing difference between the first receive timing and the second receive timing exceeds the threshold. The UE may receive, from the network entity and in response to the first message, a second message indicating for the UE to perform wireless communications with a single TRP or with two TRPs. The two TRPs may be associated with a second receive timing difference at the UE that is less than or equal to the threshold. Such techniques for receive timing difference reporting for multiple-TRP operations, as described herein, may therefore reduce network inefficiencies, among other possible benefits.

A method for wireless communication at a UE is described. The method may include receiving first signaling from a first TRP and second signaling from a second TRP, the first TRP and the second TRP both associated with a network entity, determining that a first receive timing difference between a first receive timing for the first signaling from the first TRP and a second receive timing for the second signaling from the second TRP exceeds a threshold, transmitting, to the network entity and based on the determining, a first message indicating that the first receive timing difference between the first receive timing and the second receive timing exceeds the threshold, and receiving, from the network entity and in response to the first message, a second message indicating for the UE to perform wireless communications with a single TRP or with two TRPs associated with a second receive timing difference at the UE that is less than or equal to the threshold.

An apparatus for wireless communication at a UE is described. The apparatus may include a memory, a transceiver, and at least one processor of a UE, the at least one processor coupled with the memory and the transceiver. The at least one processor may be configured to receive first signaling from a first TRP and second signaling from a second TRP, the first TRP and the second TRP both associated with a network entity, determine that a first receive timing difference between a first receive timing for the first signaling from the first TRP and a second receive timing for the second signaling from the second TRP exceeds a threshold, transmit, to the network entity and based on the determining, a first message indicating that the first receive timing difference between the first receive timing and the second receive timing exceeds the threshold, and receive, from the network entity and in response to the first message, a second message indicating for the UE to perform wireless communications with a single TRP or with two TRPs associated with a second receive timing difference at the UE that is less than or equal to the threshold.

Another apparatus for wireless communication at a UE is described. The apparatus may include means for receiving first signaling from a first TRP and second signaling from a second TRP, the first TRP and the second TRP both associated with a network entity, means for determining that a first receive timing difference between a first receive timing for the first signaling from the first TRP and a second receive timing for the second signaling from the second TRP exceeds a threshold, means for transmitting, to the network entity and based on the determining, a first message indicating that the first receive timing difference between the first receive timing and the second receive timing exceeds the threshold, and means for receiving, from the network entity and in response to the first message, a second message indicating for the UE to perform wireless communications with a single TRP or with two TRPs associated with a second receive timing difference at the UE that is less than or equal to the threshold.

A non-transitory computer-readable medium storing code for wireless communication at a UE is described. The code may include instructions executable by a processor to receive first signaling from a first TRP and second signaling from a second TRP, the first TRP and the second TRP both associated with a network entity, determine that a first receive timing difference between a first receive timing for the first signaling from the first TRP and a second receive timing for the second signaling from the second TRP exceeds a threshold, transmit, to the network entity and based on the determining, a first message indicating that the first receive timing difference between the first receive timing and the second receive timing exceeds the threshold, and receive, from the network entity and in response to the first message, a second message indicating for the UE to perform wireless communications with a single TRP or with two TRPs associated with a second receive timing difference at the UE that is less than or equal to the threshold.

Some examples of the method, apparatuses, and non-transitory computer-readable medium described herein may further include operations, features, means, or instructions for receiving, from the network entity, a transmission configuration message indicating a first transmission configuration indicator (TCI) state and a second TCI state, where the first TRP may be associated with the first TCI state and the second TRP may be associated with the second TCI state, and where receiving the first signaling from the first TRP and the second signaling from the second TRP may be based on the transmission configuration message.

In some examples of the method, apparatuses, and non-transitory computer-readable medium described herein, receiving the first signaling from the first TRP and the second signaling from the second TRP may include operations, features, means, or instructions for receiving the first signaling from the first TRP via a first beam corresponding to the first TCI state and the second signaling from the second TRP via a second beam corresponding to the second TCI state.

In some examples of the method, apparatuses, and non-transitory computer-readable medium described herein, receiving the first signaling from the first TRP and the second signaling from the second TRP may include operations, features, means, or instructions for receiving the first signaling from the first TRP via a first beam associated with a first beam index and the second signaling from the second TRP via a second beam associated with a second beam index.

In some examples of the method, apparatuses, and non-transitory computer-readable medium described herein, the first beam and the second beam correspond to a beam combination of a set of multiple beam combinations for receiving signaling from a plurality TRPs and the first receive timing difference between the first receive timing and the second receive timing corresponds to a maximum receive timing difference of a set of multiple receive timing differences determined for the set of multiple beam combinations.

In some examples of the method, apparatuses, and non-transitory computer-readable medium described herein, the first signaling and the second signaling include respective synchronization signal blocks (SSBs).

In some examples of the method, apparatuses, and non-transitory computer-readable medium described herein, the first receive timing for the first signaling corresponds to a first time at which the first signaling may be received at the UE and the second receive timing for the second signaling corresponds to a second time at which the second signaling may be received at the UE.

In some examples of the method, apparatuses, and non-transitory computer-readable medium described herein, the first TRP and the second TRP may be associated with a same timing advance group (TAG).

In some examples of the method, apparatuses, and non-transitory computer-readable medium described herein, the first TRP may be associated with a first TAG and the second TRP may be associated with a second TAG.

In some examples of the method, apparatuses, and non-transitory computer-readable medium described herein, the first receive timing for the first signaling may be based on a downlink frame timing of the first TAG and the second receive timing for the second signaling may be based on a downlink frame timing of the second TAG.

In some examples of the method, apparatuses, and non-transitory computer-readable medium described herein, the first receive timing may be based on a slot timing of the first TAG and the second receive timing for the second signaling may be based on a slot timing of the second TAG.

Some examples of the method, apparatuses, and non-transitory computer-readable medium described herein may further include operations, features, means, or instructions for transmitting, to the network entity and based on the first receive timing difference between the first receive timing and the second receive timing exceeding the threshold, a third message indicating at least two candidate TRPs, where a receive timing difference associated with signaling from the at least two candidate TRPs may be less than or equal to the threshold.

In some examples of the method, apparatuses, and non-transitory computer-readable medium described herein, the second message indicates for the UE to perform the wireless communications with the two TRPs, and the at least two candidate TRPs include the two TRPs.

In some examples of the method, apparatuses, and non-transitory computer-readable medium described herein, the at least two candidate TRPs may be indicated by at least two TCI state groups, at least two sets of SSB indices, at least two control resource set (CORESET) pool indices, at least two physical cell identifiers (PCIs), or any combination thereof.

In some examples of the method, apparatuses, and non-transitory computer-readable medium described herein, the second message indicates for the UE to perform wireless communications with the single TRP.

In some examples of the method, apparatuses, and non-transitory computer-readable medium described herein, the first message may be transmitted in accordance with a periodicity or based on determining that the first receive timing difference between the first receive timing and the second receive timing exceeds the threshold.

In some examples of the method, apparatuses, and non-transitory computer-readable medium described herein, the first message includes uplink control information, a medium access control-control element (MAC-CE), or a radio link control (RLC) message.

In some examples of the method, apparatuses, and non-transitory computer-readable medium described herein, the threshold may be based on a subcarrier spacing or a radio frequency band configured for the UE.

A method for wireless communication at a network entity is described. The method may include obtaining a first message indicating that a first receive timing difference at a UE between a first receive timing for first signaling from a first TRP associated with the network entity and a second receive timing for second signaling from a second TRP associated with the network entity exceeds a threshold and outputting a second message indicating for the UE to perform wireless communications with a single TRP or with two TRPs associated with a second receive timing difference at the UE that is less than or equal to the threshold.

An apparatus for wireless communication at a network entity is described. The apparatus may include a memory and at least one processor of a network entity, the at least one processor coupled with the memory. The at least one processor may be configured to obtain a first message indicating that a first receive timing difference at a UE between a first receive timing for first signaling from a first TRP associated with the network entity and a second receive timing for second signaling from a second TRP associated with the network entity exceeds a threshold and output a second message indicating for the UE to perform wireless communications with a single TRP or with two TRPs associated with a second receive timing difference at the UE that is less than or equal to the threshold.

Another apparatus for wireless communication at a network entity is described. The apparatus may include means for obtaining a first message indicating that a first receive timing difference at a UE between a first receive timing for first signaling from a first TRP associated with the network entity and a second receive timing for second signaling from a second TRP associated with the network entity exceeds a threshold and means for outputting a second message indicating for the UE to perform wireless communications with a single TRP or with two TRPs associated with a second receive timing difference at the UE that is less than or equal to the threshold.

A non-transitory computer-readable medium storing code for wireless communication at a network entity is described. The code may include instructions executable by a processor to obtain a first message indicating that a first receive timing difference at a UE between a first receive timing for first signaling from a first TRP associated with the network entity and a second receive timing for second signaling from a second TRP associated with the network entity exceeds a threshold and output a second message indicating for the UE to perform wireless communications with a single TRP or with two TRPs associated with a second receive timing difference at the UE that is less than or equal to the threshold.

Some examples of the method, apparatuses, and non-transitory computer-readable medium described herein may further include operations, features, means, or instructions for outputting a transmission configuration message indicating a set of multiple TCI states, where the first TRP may be associated with a first TCI state of the set of multiple TCI states and the second TRP may be associated with a second TCI state of the set of multiple TCI states.

In some examples of the method, apparatuses, and non-transitory computer-readable medium described herein, the first receive timing corresponds to a first time at which the first signaling may be received at the UE from the first TRP and the second receive timing corresponds to a second time at which the second signaling may be received at the UE from the second TRP.

In some examples of the method, apparatuses, and non-transitory computer-readable medium described herein, the first TRP and the second TRP may be associated with a same TAG.

In some examples of the method, apparatuses, and non-transitory computer-readable medium described herein, the first TRP may be associated with a first TAG and the second TRP may be associated with a second TAG.

Some examples of the method, apparatuses, and non-transitory computer-readable medium described herein may further include operations, features, means, or instructions for obtaining a third message indicating at least two candidate TRPs, where a receive timing difference associated with signaling from the at least two candidate TRPs may be less than or equal to the threshold, and where outputting the second message may be based on obtaining the third message.

### BRIEF DESCRIPTION OF THE DRAWINGS

FIGS. 1 and 2 each illustrate an example of a wireless communications system that supports receive timing difference reporting for multiple transmission-reception point (TRP) operation in accordance with one or more aspects of the present disclosure.

FIG. 3 illustrates an example of a timing diagram that supports receive timing difference reporting for multiple-TRP (multi-TRP) operation in accordance with one or more aspects of the present disclosure.

FIG. 4 illustrates an example of a process flow that supports receive timing difference reporting for multi-TRP operation in accordance with one or more aspects of the present disclosure.

FIGS. 5 and 6 show block diagrams of devices that support receive timing difference reporting for multi-TRP operation in accordance with one or more aspects of the present disclosure.

FIG. 7 shows a block diagram of a communications manager that supports receive timing difference reporting for multi-TRP operation in accordance with one or more aspects of the present disclosure.

FIG. 8 shows a diagram of a system including a device that supports receive timing difference reporting for multi-TRP operation in accordance with one or more aspects of the present disclosure.

FIGS. 9 and 10 show block diagrams of devices that support receive timing difference reporting for multi-TRP operation in accordance with one or more aspects of the present disclosure.

FIG. 11 shows a block diagram of a communications manager that supports receive timing difference reporting for multi-TRP operation in accordance with one or more aspects of the present disclosure.

FIG. 12 shows a diagram of a system including a device that supports receive timing difference reporting for multi-TRP operation in accordance with one or more aspects of the present disclosure.

FIGS. 13 through 17 show flowcharts illustrating methods that support receive timing difference reporting for multi-TRP operation in accordance with one or more aspects of the present disclosure.

### DETAILED DESCRIPTION

Some wireless communications systems may include a communication device, such as a user equipment (UE) or a network entity, that support wireless communications over one or more radio access technologies (RATs). Examples of RATs may include fourth generation (4G) systems, such as Long Term Evolution (LTE) systems, and fifth generation (5G) systems, which may be referred to as NR systems. The communication device may operate in a half-duplex mode or a full-duplex mode, or a combination thereof. For example, in a half-duplex mode, the communication device may either transmit communications or receive communications during a time period, such as a transmission time interval (TTI) that may span one or more time resources (e.g., symbols, mini-slots, slot). In a full-duplex mode, the communication device may transmit and receive communications simultaneously or concurrently. That is, communications received by the communication device may overlap in the time domain with communications transmitted by the communication device. For example, symbols occupied by or allocated for received signals may overlap with symbols occupied by or allocated for transmitted signals.

In some wireless communications systems, a network entity may support communications for a communication device (e.g., a UE) via one or more transmission-reception points (TRPs). For example, a wireless communications system may support multiple-TRP (multi-TRP, or mTRP) operations in which the UE may simultaneously communicate with multiple TRPs, thereby reducing signaling overhead, increasing throughput, and extending wireless coverage for the UE. For multi-TRP operations, the UE may adjust the timing at which the UE transmits the uplink communications to each of the multiple TRPs, such that the uplink communications may be aligned for the multiple TRPs (e.g., synchronized at the network). In some examples, the UE may adjust (e.g., advance) uplink transmissions to a TRP based on a propagation delay of downlink transmissions from the TRP. For example, multiple (e.g., two) TRPs may be spatially located such that a propagation delay, and therefore a receive timing, associated with signaling from a first TRP may be different from a propagation delay, and therefore receive timing, associated with signaling from a second TRP. As such, the UE may adjust the timing of uplink transmissions to the first TRP and the second TRP based on the respective receive timings associated with each TRP.

In some examples, the UE may be configured for inter-cell multi-TRP operations, in which the UE may communicate with the first TRP and the second TRP over multiple (e.g., different) serving cells. In such examples, the UE may be capable of handling a threshold timing difference (e.g., a maximum receive timing difference, a relative receive timing difference, or an otherwise suitable receive timing difference) between signals received at the UE from the first TRP and the second TRP, such that the UE may maintain simultaneous uplink transmissions for the first TRP and the second TRP (e.g., with reduced inter-TRP interference). In other examples, however, the UE may be configured for intra-cell multi-TRP operations, in which the first TRP and the second TRP may operate in a same cell. In such examples, the UE may not be capable of handling the threshold timing difference between the signals received from the first TRP and the second TRP. For example, a timing difference that the UE may be capable of handling for inter-cell multi-TRP operations may be relatively larger than the timing difference that the UE may be capable of handling for intra-cell multi-TRP operations.

Various aspects of the present disclosure generally relate to techniques for receive timing difference reporting for multi-TRP operation and more specifically, to configuring a UE to determine whether a difference between receive timings associated with multiple TRPs exceeds a threshold. For example, the UE may report, to the network, whether a timing difference between signals received from multiple intra-cell TRPs exceed a threshold timing difference (e.g., a maximum receive timing difference, a relative receive timing difference, or an otherwise suitable receive timing difference). The UE may determine a first receive timing associated with the first TRP and a second receive timing associated with the second TRP. In some examples, if a difference between the first receive timing and the second receive timing exceeds the threshold timing difference, the UE may transmit a report to the network. For example, the UE may transmit a report, to the network, indicating that a receive timing difference between the first TRP and the second TRP exceeds the threshold timing difference. In some examples, the report may indicate other TRPs in which the receive timing difference fails to exceed (e.g., is less than or equal to) the threshold timing difference.

In some examples, the first TRP and the second TRP may be associated with a same timing advance group (TAG). In such examples, the UE may determine a receive timing associated with the first TRP and the second TRP based on signals, such as synchronization signals, received by the UE from the respective TRPs. In other examples, the first TRP and the second TRP may be associated with different TAGs. In such examples, the UE may determine the receive timing for the first TRP and the second TRP based on the TAG configured for the respective TRPs. In response to receive the report indicating that the receive timing difference between the first TRP and the second TRP exceeds the receive timing threshold, the network may, in some examples, indicate for the UE to operate in a single TRP mode. Additionally, or alternatively, the network may determine to activate multi-TRP operations for other TRPs. For example, the network may determine to activate multi-TRP operations for the other TRPs indicated to the network via the report (e.g., the other TRPs for which a receive timing difference does not exceed the receive timing threshold).

Particular aspects of the subject matter described herein may be implemented to realize one or more advantages. The described techniques may support improvements in wireless communications systems by reducing network inefficiencies. Further, in some examples, receive timing difference reporting for multi-TRP operations, as described herein, may support reduced signaling overhead and increased throughput, thereby improving performance. As such, supported techniques may provide improved network operations, and, in some examples, may promote network efficiencies, among other benefits.

Aspects of the disclosure are initially described in the context of wireless communications systems. Aspects of the disclosure are also described in the context of a timing diagram and a process flow. Aspects of the disclosure are further illustrated by and described with reference to apparatus diagrams, system diagrams, and flowcharts that relate to receive timing difference reporting for multi-TRP operation.

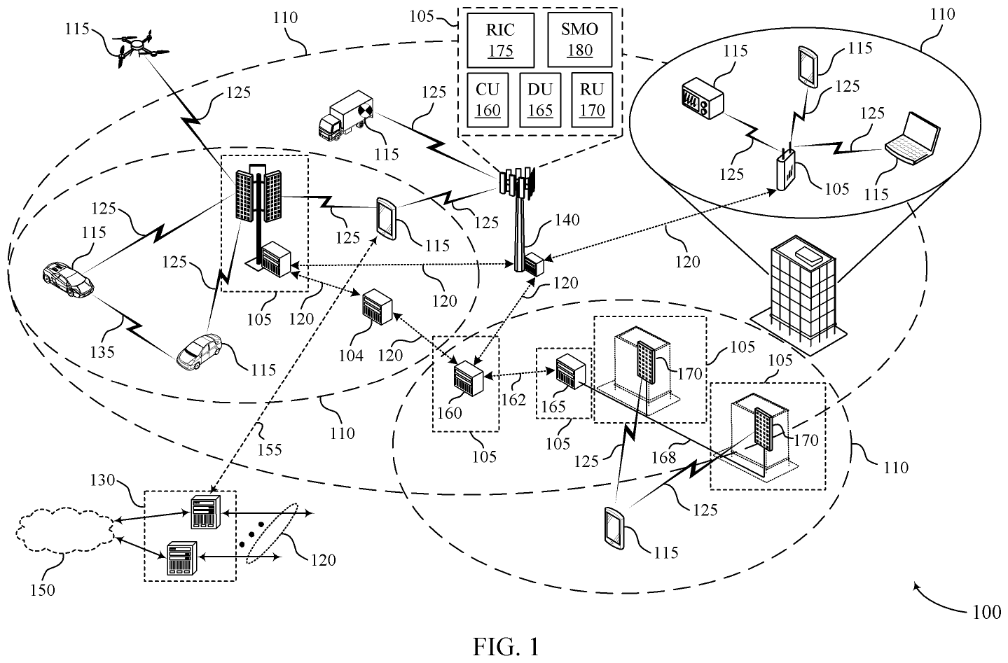

FIG. 1 illustrates an example of a wireless communications system 100 that supports receive timing difference reporting for multi-TRP operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support receive timing difference reporting for multi-TRP operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCI), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support receive timing difference reporting for multi-TRP operation. For example, the described techniques provide for determining, at a UE 115, whether a receive timing difference associated with multiple TRPs exceeds a threshold. In some examples, the UE 115 may receive first signaling from a first TRP and second signaling from a second TRP, the first TRP and the second TRP both associated with a network entity 105. The UE 115 may determine that a first receive timing difference between a first receive timing for the first signaling from the first TRP and a second receive timing for the second signaling from the second TRP exceeds a threshold. The UE 115 may transmit, to the network entity 105 and based on the determining, a first message indicating that the first receive timing difference between the first receive timing and the second receive timing exceeds the threshold. The UE 115 may receive, from the network entity 105 and in response to the first message, a second message indicating for the UE 115 to perform wireless communications with a single TRP or with two TRPs. The two TRPs may be associated with a second receive timing difference at the UE 115 that is less than or equal to the threshold. In some examples, by reporting, to the network entity 105, that the receive timing difference between the first receive timing and the second receive timing exceeds the threshold, the UE 115 may reduce network inefficiencies, among other possible benefits.

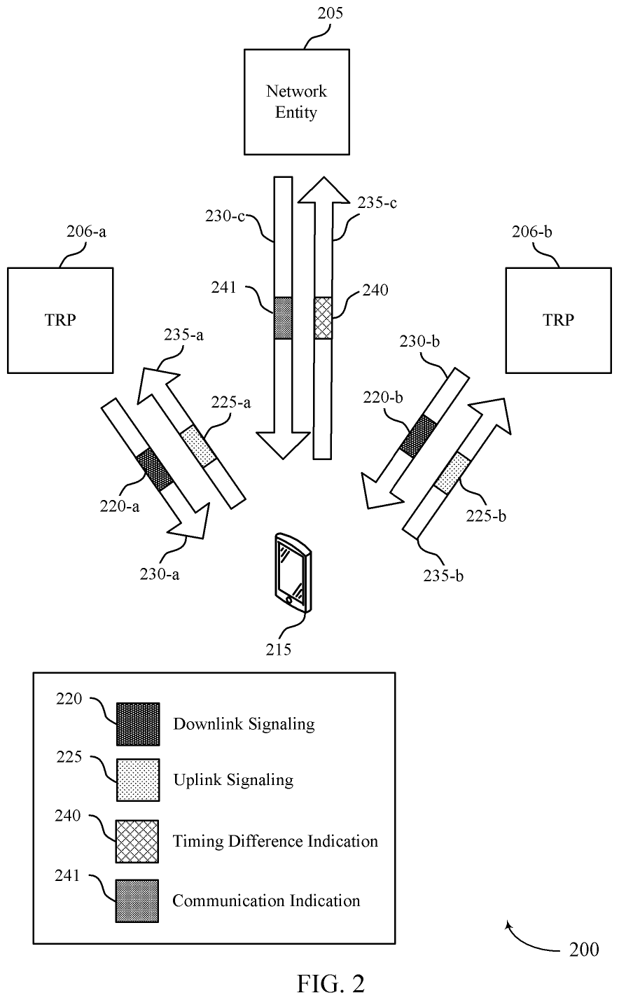

FIG. 2 illustrates an example of a wireless communications system 200 that supports receive timing difference reporting for multi-TRP operation in accordance with one or more aspects of the present disclosure. The wireless communications system 200 may implement or be implemented by one or more aspects of the wireless communications system 100. For example, the wireless communications system 200 may include a UE 215 and a network entity 205, which may be examples of the corresponding devices as described with reference to FIG. 1. The UE 215 and the network entity 205 may communicate via one or more communication links (e.g., an uplink 235-c and a downlink 230-c). The wireless communications system 200 may also include one or more TRPs 206 (e.g., a TRP 206-a and a TRP 206-b). In the example of FIG. 2, the TRP 206-a and the TRP 206-b may be examples of an RU 170 (or one or more other components of the network entity 205) as described with reference to FIG. 1. Additionally, or alternatively, in the example of FIG. 2, the UE 215 may receive communications from the TRP 206-a and the TRP 206-b via a downlink 230-a and a downlink 230-b, respectively, and may transmit communications to the TRP 206-a and the TRP 206-b via an uplink 235-a and an uplink 235-b, respectively. The TRP 206-a and the TRP 206-b may communicate with each other and the network entity 205 via one or more backhaul links (not shown). The downlinks 230 and the uplinks 235 may each be examples of a communication link 125 as described with reference to FIG. 1.

As illustrated in the example of FIG. 2, the wireless communications system 200 may support multi-TRP operations, in which the UE 215 may simultaneously communicate with the TRP 206-a and the TRP 206-b. For some multi-TRP operations, the UE 215 may adjust the timing at which the UE 215 transmits the uplink communications to the TRP 206-a and the TRP 206-b, such that the uplink communications may be aligned for the TRP 206-a and the TRP 206-b (e.g., synchronized at the network). In some examples, the network may configure the UE 215 to adjust the timing of uplink transmissions to the TRP 206-a and the TRP 206-b according to one or multiple timing advance values. For example, the network (e.g., the network entity 205) may configure the UE 215 to adjust a timing at which the UE 215 may transmit uplink signaling 225-a (e.g., to the TRP 206-a) and uplink signaling 225-b (e.g., to the TRP 206-b) according to one or multiple timing advance values (e.g., that may be based on a respective propagation delay associated with the TRP 206-a and the TRP 206-b). In some examples, the network may configure the UE 215 to apply a single (e.g., a same) timing advance value or multiple (e.g., different) timing advance values to uplink transmissions to the TRP 206-a and the TRP 206-b.

For example, the wireless communications system 200 may support multi-TRP operations in which the TRP 206-a and the TRP 206-b may each schedule uplink transmissions from the UE 215 to the respective TRP 206. For example, the TRP 206-a may transmit a control message (e.g., a downlink control information (DCI)) scheduling uplink transmissions from the UE 215 to the TRP 206-a. Additionally, or alternatively, the TRP 206-b may transmit another control message (e.g., another DCI) scheduling uplink transmissions from the UE 215 to the TRP 206-b. In some examples, such multi-TRP operations may be referred to as multiple DCI (multi-DCI) multi-TRP operations. In some examples of multi-DCI multi-TRP operations, the TRP 206-a and the TRP 206-b may serve different cells. That is, the UE 215 may be configured for inter-cell multi-TRP operations with the TRP 206-a and the TRP 206-b. In such an example, the network may configure the UE 215 with multiple timing advance values (e.g., one for each TRP 206). For example, the TRP 206-a and the TRP 206-b may be associated with different TAGs that may each be configured with a different timing advance value. In such an example, the UE 215 may apply the different timing advance values for uplink transmission to the TRP 206-a and the TRP 206-b. For example, the UE 215 may apply a first timing advance value for transmitting the uplink signaling 225-a to the TRP 206-a and a second timing advance value for transmitting the uplink signaling 225-b to the TRP 206-b.

Additionally, or alternatively, the wireless communications system 200 may support multi-TRP operations in which the TRP 206-a or the TRP 206-b may schedule uplink transmissions for the UE 215. For example, the TRP 206-a (or the TRP 206-b) may transmit a single control message (e.g., a single DCI) scheduling uplink transmissions from the UE 215 to the TRP 206-a and the TRP 206-b. In some examples, such multi-TRP operations may be referred to as single-DCI multi-TRP operations. In some examples of single-DCI multi-TRP operations (e.g., where a unified transmission configuration indicator (TCI) framework extension may be assumed), power control for uplink transmissions from the UE 215 (e.g., the uplink signaling 225-a and the uplink signaling 225-b) may be based on control signaling from the scheduling TRP (e.g., the TRP 206-a, the TRP 206 that transmits the single-DCI scheduling uplink transmissions for both the TRP 206-a and the TRP 206-b). For simultaneous uplink transmission from multiple panels (e.g., at the UE 215), power control operations may depend on (e.g., may be limited to) one or more scenarios. For example, power control operations for simultaneous uplink transmission from multiple panels may change based on implementation of one or multiple devices operating within the wireless communications system 200 (e.g., the UE 215, the network entity 205, the TRPs 206, or any combination thereof). In some examples of single-DCI multi-TRP operations, the TRP 206-a and the TRP 206-b may be associated with a same TAG. In such an example, the UE 215 may be configured to apply a same timing advance value (e.g., a timing advance value configured for the TAG) for uplink transmission to the TRP 206-a and the TRP 206-b. For example, the UE 215 may apply a same timing advance value for transmitting the uplink signaling 225-a to the TRP 206-a and the uplink signaling 225-b to the TRP 206-b.

In some examples, the UE 215 may apply a timing advance value for an uplink transmission based on (e.g., with respect to) a corresponding downlink transmission. For example, the UE 215 may have (e.g., be configured with) a capability to follow a frame timing change of the reference cell (e.g., a cell served by one or more of the TRPs 206) in connected state. In such an example, a frame of the uplink transmission (e.g., the uplink frame transmission) may occur (e.g., be advanced) some amount of time before the reception of a first detected path (e.g., in time) of a frame of a corresponding downlink transmission (e.g., the corresponding downlink frame) from the reference cell (e.g., from the TRP 206 serving the reference cell). For example, the UE 215 may apply a timing advance value configured for the TRP 206-a such that a frame over which the UE 215 transmits the uplink signaling 225-a to the TRP 206-a may occur prior to a frame of a corresponding downlink transmission (e.g., a frame used to transmit downlink signaling 220-a) received at the UE 215. Additionally, or alternatively, the UE 215 may apply another timing advance value configured for the TRP 206-b (e.g., a same or a different timing advance value as may be configured for the TRP 206-a) such that a frame over which the UE 215 transmits the uplink signaling 225-b to the TRP 206-b may occur prior to a frame of a corresponding downlink transmission (e.g., a frame used to transmit downlink signaling 220-b) received at the UE 215. In some examples, a frame of an uplink transmission may be advanced (e.g., with respect to a frame of corresponding downlink transmission) in accordance with Equation 1:

$$( {N}_{TA} + {N}_{TA , offset} ) {T}_{c} \qquad ( 1 )$$

where the parameter N_{TA} may represent a timing advance value, the parameter N_{TA,offset} may represent a timing advance offset value, and the parameter T_{c} may represent a timing unit of a wireless communications system, such as a basic timing unit for an NR system.

In some examples, the UE 215 may be configured with a timing advance offset (e.g., a fixed timing advanced offset). The network may provide the UE 215 with a value of a timing advance offset (N_{TA,offset}) for a serving cell via an information element (IE), such as via a n-TimingAdvanceOffset IE for the serving cell. In some examples, if the UE 215 is not provided the n-TimingAdvanceOffset IE for a serving cell, the UE 215 may determine a default value of the timing advance offset (N_{TA,offset}) for a serving cell. Additionally, or alternatively, if the UE 215 is configured with multiple (e.g., two) uplink carriers for a serving cell, such as for carrier aggregation, a same timing advance offset value may be applied to both carriers. For example, upon (e.g., at a timing of or subsequent to) reception of a timing advance command for a TAG, the UE 215 may adjust the timing of uplink transmissions (e.g., the timing of physical uplink shared channel (PUSCH) transmissions, sounding reference signal (SRS) transmissions, or physical uplink control channel (PUCCH) transmissions) on each serving cell in the TAG based on the timing advance offset value (N_{TA,offset}). In some examples, the UE 215 may apply a same timing advance value for each serving cell of the TAG based on the received timing advance command in which the uplink timing (e.g., the timing of PUSCH transmissions, the SRS transmissions, or the PUCCH transmissions) may be the same for all of the serving cells in the TAG. It is to be understood that the names of IEs described herein may change based on implementation of one or multiple devices (e.g., the UE 215, the network entity 205, the TRPs 206, or any combination thereof), and the examples described herein should not be considered limiting to the scope covered by the claims or the disclosure.

In some examples, the UE 215 may be configured to apply a non-accumulative (e.g., absolute) timing advance value. For example, the UE 215 may receive a random access response or an absolute timing advance command (e.g., via an absolute timing advance command MAC control element (MAC-CE)) for a TAG that may indicate a timing advance value (N_{TA}) via an index. For example, the absolute timing advance command (T_{A}) for a TAG may indicate a timing advance value (N_{TA}) via index values of T_{A} (e.g., T_{A}=0, 1, 2, . . . , 3846). In such an example, an amount of the timing alignment (e.g., a value of the timing adjustment) for the TAG may depend on a subcarrier spacing (e.g., of 2^{μ}·15 kHz) configured for the UE 215 (or the TRP 206). For example, the amount of the timing alignment for the TAG may be determined in accordance with Equation 2:

$${N}_{TA} = {T}_{A} \cdot 16 \cdot 64 / {2}^{μ} . \qquad ( 2 )$$

In some examples, the timing advance value (N_{TA}) may be relative to the subcarrier spacing of a first uplink transmission from the UE 215 after reception of the random access response or the absolute timing advance command (e.g., the absolute timing advance command MAC-CE).

In some examples, the UE 215 may be configured to apply an accumulative (e.g., relative) timing advance value. For example, the UE 215 may receive a timing advance command (TA) for a TAG that may indicate an adjustment of a timing advance value (N_{TA}), such as an adjustment to a current (or previous) timing advance value (N_{TA_old}). For example, the UE 215 may determine the timing advance value (N_{TA_new}) from the current (or previous) timing advance value (N_{TA_old}) based on the index value of the timing advance command (T_{A}=0, 1, 2, . . . , 63). In such an example, the amount of the timing alignment may be determined in accordance with Equation 3:

$${N}_{TA \_ new} = {N}_{TA \_ old} + ( {T}_{A} - 31 ) \cdot 16 \cdot 64 / {2}^{μ} . \qquad ( 3 )$$

In some examples, the UE 215 may be configured for carrier aggregation. For example, the UE 215 may be configured for intra-band carrier aggregation, in which the network may configure the UE 215 to aggregate two or more carriers across a same radio frequency band. In such an example, the UE 215 may be capable of handling at least a relative receive timing difference between a timing (e.g., a slot timing) of the difference carriers to be aggregated at the UE 215 receiver. In other examples, the UE 215 may be configured for inter-band carrier aggregation, in which the network may configure the UE 215 to aggregate two or more carriers between multiple (e.g., separate) radio frequency bands. In such an example, the UE 215 may be capable of handling at least a relative timing difference between a timing (e.g., a slot timing) of the pairs of carriers to be aggregated at the UE 215 (e.g., the UE 215 receiver).

Additionally or alternatively, for inter-cell multi-TRP operations, the receive timing associated with different TRPs 206 may satisfy (e.g., fulfill) a threshold timing difference (Tₑ), such as to maintain simultaneous uplink transmissions with reduced inter-TRP interference. In some examples, however, the UE 215 may be configured for intra-cell multi-TRP operations, in which the TRP 206-a and the TRP 206-b may operate in a same cell (e.g., served by the network entity 205). In such examples, the UE 215 may not be capable of handling the threshold timing difference between the signals received from the TRP 206-a and the TRP 206-b. For example, a threshold timing difference that the UE 215 may be capable of handling for inter-cell multi-TRP operations may be larger than a threshold timing difference that the UE 215 may be capable of handling for intra-cell multi-TRP operations.

Various aspects of the present disclosure may provide one or more enhancements to multi-TRP operations. For example, the described techniques may provide for determining, at the UE 215, whether a receive timing difference associated with the TRP 206-a and the TRP 206-b exceeds a threshold. In some examples, the UE 215 may receive first signaling (e.g., the downlink signaling 220-a) from the TRP 206-a and second signaling (e.g., the downlink signaling 220-b) from the TRP 206-b. In such examples, the TRP 206-a and the TRP 206-b may both be associated with (e.g., served by, controlled by) the network entity 205. The UE 215 may determine that a first receive timing difference between a first receive timing for the downlink signaling 220-a from the TRP 206-a and a second receive timing for the downlink signaling 220-b from the TRP 206-b exceeds a threshold. The UE 215 may transmit, to the network entity 205 (e.g., based on the determining) a first message indicating that the first receive timing difference between the first receive timing and the second receive timing exceeds the threshold. For example, the UE 215 may transmit the timing difference indication 240 to the network entity 205. The UE 215 may receive, from the network entity 205 and in response to the timing difference indication 240, a second message indicating for the UE 215 to perform wireless communications with a single TRP or with two TRPs. For example, the UE 215 may receive a communication indication 241 from the network entity 205. The two TRPs may be associated with a second receive timing difference at the UE 215 that is less than or equal to the threshold. In some examples, the communication indication 241 may indicate for the UE 215 to perform communications with a single TRP or with two (e.g., other) TRPs (e.g., a third TRP and a fourth TRP). In some examples, by transmitting the timing difference indication 240 (e.g., indicating that the first receive timing difference between the first receive timing and the second receive timing exceeds the threshold), the UE 215 may improve synchronization reliability within the wireless communications system 200, thereby reducing network inefficiencies, among other possible benefits.

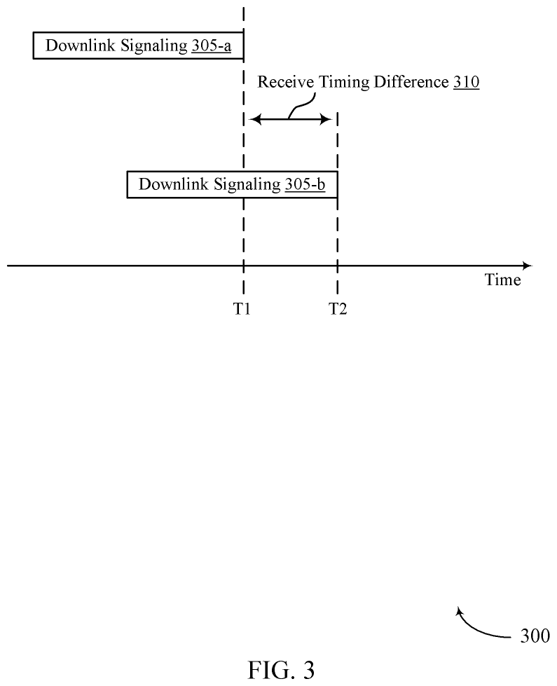

FIG. 3 illustrates an example of a timing diagram 300 that supports receive timing difference reporting for multi-TRP operation in accordance with one or more aspects of the present disclosure. The timing diagram 300 may implement or be implemented by one or more aspects of the wireless communications system 100 and the wireless communications system 200. For example, the timing diagram 300 may be implemented by a UE, one or more TRPs, and a network entity, which may be examples of the corresponding devices as described with reference to FIGS. 1 and 2. For example, the one or more TRPs may be examples of an RU 170 (or one or more other components of the network entity 205) as described with reference to FIG. 1.

As illustrated in the example of FIG. 3, a communication device (e.g., the UE) may report, to the network (e.g., one or more network entities), whether a receive timing difference 310 between signaling received from multiple TRPs (e.g., multiple intra-cell TRPs) satisfies a threshold. For example, the UE may determine whether a receive timing difference 310 between downlink signaling 305-a (e.g., received from a first TRP at a time T1) and downlink signaling 305-b (e.g., received from a second TRP at a time T2) satisfies (e.g., exceeds) a threshold timing difference (The). In some examples, if the receive timing difference 310 exceeds the threshold timing difference (The), the UE may transmit a report to the network. While the example of FIG. 3 illustrates different receiving timings for the downlink signaling 305-a and the downlink signaling 305-b (e.g., receiving timings occurring at T1 and T2, respectively), it is to be understood that the receive timings of downlink signaling received at a UE from multiple TRPs may occur at a same time or at different times. For example, the receiving timing of downlink signaling received at a UE from multiple TRPs may change based on a propagation delay or a transmit timing (or both) associated with the corresponding signaling and the examples described herein should not be considered limiting to the scope covered by the claims or the disclosure.

In some examples, the UE may be configured to operate in a single-DCI multi-TRP mode (e.g., configured to perform single-DCI multi-TRP operations), in which a single TAG may be configured (e.g., for the multiple TRPs participating in the single-DCI multi-TRP operations). That is, the UE may be configured to perform multi-TRP operations with multiple (e.g., two) TRPs that may be associated with a same TAG (e.g., indicated via a same TAG identifier). In such an example, a receive timing associated with a TRP (e.g., each of the two TRPs) may be based on signals (e.g., synchronization signals, such as synchronization signal blocks (SSBs)) received at the UE from the TRP. For example, the UE may determine whether the receive timing associated with multiple SSBs (e.g., SSBs received at the UE from each of the two TRPs) satisfies the threshold timing difference (e.g., fulfill a Tₑ constraint), such that the UE may maintain simultaneous uplink transmissions (e.g., with the two TRPs) using the single TAG.

In some examples, the UE may report whether two TCI states or two SSBs (e.g., a TCI state or an SSB associated with each of the two TRPs) have a receive timing difference that exceeds (e.g., is greater than) a threshold (e.g., the threshold timing difference, Tₑ). For example, the receive timing difference determined at the UE may correspond to a receive timing difference between TCI states (e.g., two or more TCI states selected by the network and indicated to the UE) that each correspond to a different TRP. In some examples, the network may indicate selected TCI states to the UE via a transmission configuration message. In some examples, the UE may determine a beam for communicating with the multiple TRPs based on quasi co-location relationships indicated by the TCI states (e.g., corresponding to the multiple TRPs). For example, the UE may receive first signaling from a first TRP via a first beam corresponding to a first TCI state (e.g., associated with the first TRP) and second signaling from a second TRP via a second beam corresponding to a second TCI state (e.g., associated with the first TRP).

Additionally or alternatively, the receive timing difference determined at the UE may correspond to a receive timing difference between two SSBs received at the UE from the different TRPs (e.g., an SSB received from each of the two TRPs). For example, a receive timing (e.g., from which the receive timing difference is determined) may correspond to a time at which an SSB is received at the UE from each TRP. In some examples, the UE may receive multiple SSBs from multiple TRPs. In such an example, the receive timing difference may correspond to a relatively high receive timing difference (e.g., a maximum receive timing difference or an otherwise suitable receive timing difference) among multiple combinations of SSBs (e.g., all pairs) received at the UE from multiple combinations of TRPs. In some examples, an SSB may be associated with an SSB index (e.g., a beam index). For example, the UE may identify one or more beams for communicating with the multiple TRPs based on an index associated with the received SSBs. That is, the UE may receive one or more SSBs from a first TRP via a first beam (e.g., associated with a first beam index, an SSB index) and one or more other SSBs from a second TRP via a second beam (e.g., associated with a second beam index, another SSB index).

In some examples, the threshold (e.g., the threshold timing difference, Tₑ) may be different per radio frequency band or per subcarrier spacing. For example, the threshold timing difference may depend on a radio frequency band or a subcarrier spacing configured for the UE (e.g., a subcarrier spacing of the received downlink signaling, a subcarrier spacing of transmitted uplink signaling). In some examples, the threshold timing difference for single-DCI multi-TRP operations (or multi-DCI TRP operations) may be configured for the UE according to the following Table 1:

TABLE 1

| Frequency Range | Threshold (μs) |
|---|---|
| FR2 | 3 |
| FR1 | 0.26 |

In some examples, the UE may report whether a receiving timing difference associated with multiple TRPs exceeds the threshold timing difference periodically or based on an event. For example, the UE may transmit a report indicating that a receive timing difference between two (or more) TRPs exceeds the threshold timing difference periodically or based on an event (e.g., the report may be periodic, or event triggered). In some examples, the report may be transmitted by the UE as uplink control information, such as in a CSI report. Additionally, or alternatively, the UE may transmit the report via a MAC-CE or in UE assistant information (e.g., via higher layer signaling, via radio link control (RLC) layer signaling).

In some examples, in response to receiving a UE report (e.g., a report indicating that the receive timing difference between two TRPs exceeds the threshold timing difference), the network my indicate for the UE to perform (e.g., to fall back to) single TRP operations. Additionally or alternatively, the network may activate multi-TRP operations for other TRPs. For example, the UE may report (e.g., in a same report or a different report as the report indicating that the receive timing difference between two TRPs exceeds the threshold timing difference) a number candidate TRPs that may be used for simultaneous uplink transmissions, such as during the single-DCI multi-TRP operations (e.g., while satisfying the threshold timing difference, while fulfilling the Tₑ constraint). For example, the UE may indicate which TRPs (e.g., of multiple TRPs configured for communications with the UE) may be used for simultaneous uplink transmissions during single-DCI multi-TRP operations, while satisfying the threshold timing difference. In some examples, a TRP may correspond to a TCI state group or a set of SSB indices. For example, the UE may report candidate TRPs by indicating one or more TCI state groups or one or more sets of SSB indices that correspond to the candidate TRPs. In some examples, in response to the UE reported candidate TRPs (e.g., in response to receiving a report from the UE indicating the candidate TRPs), the network may indicate two (or more) TRPs to be used by the UE for performing multi-TRP operations. For example, the network may activate two (e.g., a pair) of TRPs for the single-DCI multi-TRP operation. In some examples, the two (or more) TRPs activated for the UE to perform the single-DCI multi-TRP operations may be candidate TRPs (e.g., indicate to the network by the UE via the report).

In some examples, the UE may be configured to operate in a multi-DCI multi-TRP mode (e.g., configured to perform multi-DCI multi-TRP operations), in which two TAG may be configured (e.g., for the multiple TRPs participating in the multi-DCI multi-TRP operations, where two DCIs in CORESET of different CORESET pool indexes may schedule downlink or uplink transmissions separately). That is, the UE may be configured to perform multi-TRP operations with multiple (e.g., two) TRPs that may be associated with different TAGs (e.g., indicated via different TAG identifiers). In such an example, a receive timing of a TRP (e.g., each of the two TRPs) may be based on a receive timing (e.g., a timing advance value) associated with the respective TAG. The UE may determine whether a receive timing associated with the different TAGs (e.g., a TAG configured for each TRP and associated with a CORESET pool index) satisfies the threshold timing difference (e.g., fulfills a Tₑ constraint), such that the UE may maintain simultaneous uplink transmissions (e.g., with the two TRPs) using the multiple TAGs, for example while reducing inter-TRP interference. In such an example, the receive timing (e.g., of a TRP) may correspond to a first detected path (e.g., in time) of a corresponding downlink frame of the TAG from the reference cell. That is, the receive timing of a TRP may correspond to (e.g., be based on) the reception of a first detected path (e.g., in time) of a frame of a corresponding downlink transmission (e.g., the corresponding downlink frame) from the TRP (e.g., of a TAG from the reference cell). Additionally, or alternatively, the receive timing of a TRP may correspond to a slot timing of (e.g., derived for, derived from) the respective TAG.

In some examples, the UE may report whether the difference between the two receive timings (e.g., a receive timing for each of the two TAGs) exceeds (e.g., is greater than) the threshold (e.g., the threshold timing difference, Tₑ). In some examples, the threshold timing difference may be different per radio frequency band or per subcarrier spacing. For example, the threshold timing difference may be an example of a threshold configured according to Table 1. That is, the threshold timing difference may depend on a radio frequency band or a subcarrier spacing configured for the UE (e.g., a subcarrier spacing of the received downlink signaling, a subcarrier spacing of transmitted uplink signaling). In some examples, the UE may transmit a report indicating that a receive timing difference between two TRPs exceeds the threshold timing difference periodically or based on an event. For example, the UE may report that a receive timing difference between two (or more) TRPs exceeds the threshold timing difference periodically or based on an event being triggered (e.g., the report may be periodic, or event triggered). In some examples, the report may be transmitted by the UE as uplink control information, such as in a CSI report. Additionally, or alternatively, the UE may transmit the report via a MAC-CE or in UE assistant information (e.g., via higher layer signaling, via RLC layer signaling).

In some examples, in response to a UE report (e.g., in response to receive a report from the UE indicating that a difference between the receive timing of the two TRPs exceeds the threshold), the network may indicate for the UE to perform single TRP operations (e.g., may indicate for the UE to fall back to single TRP operation). Additionally or alternatively, the network may activate multi-TRP operations for other TRPs. For example, the UE may report (e.g., in a same report or a different report as the report indicating that the receive timing difference between two TRPs exceeds the threshold timing difference) a number candidate TRPs that may be used for simultaneous uplink transmissions, such as during the multi-DCI multi-TRP operations (e.g., while satisfying the threshold timing difference, while fulfilling the Tₑ constraint). For example, the UE may transmit a report indicating which TRPs (e.g., of multiple TRPs configured for communications with the UE) may be used for simultaneous uplink transmissions, such as during the multi-DCI multi-TRP operations, while satisfying the threshold timing difference.

In some examples, a TRP may correspond to a TCI state group, a CORESET pool index, a set of SSB indices, or a PCI index. For example, the UE may report candidate TRPs by indicating one or more TCI state groups, one or more CORESET pool indices, one or more sets of SSB indices, or one or more PCIs that may each correspond to a candidate TRP. In some examples, in response to the UE reported candidate TRPs (e.g., in response to receiving a report from the UE indicating the candidate TRPs), the network may indicate two (or more) TRPs to be used by the UE for performing multi-TRP operations (e.g., the multi-DCI multi-TRP operations). For example, the network may activate two (e.g., a pair) of TRPs for the multi-DCI multi-TRP operation. In some examples, the two (or more) TRPs activated for the UE to perform the multi-DCI multi-TRP operations may be candidate TRPs (e.g., indicate to the network by the UE via the report). In some examples, by indicating candidate TRPs to the network, the UE may improve network inefficiencies, among other possible benefits.

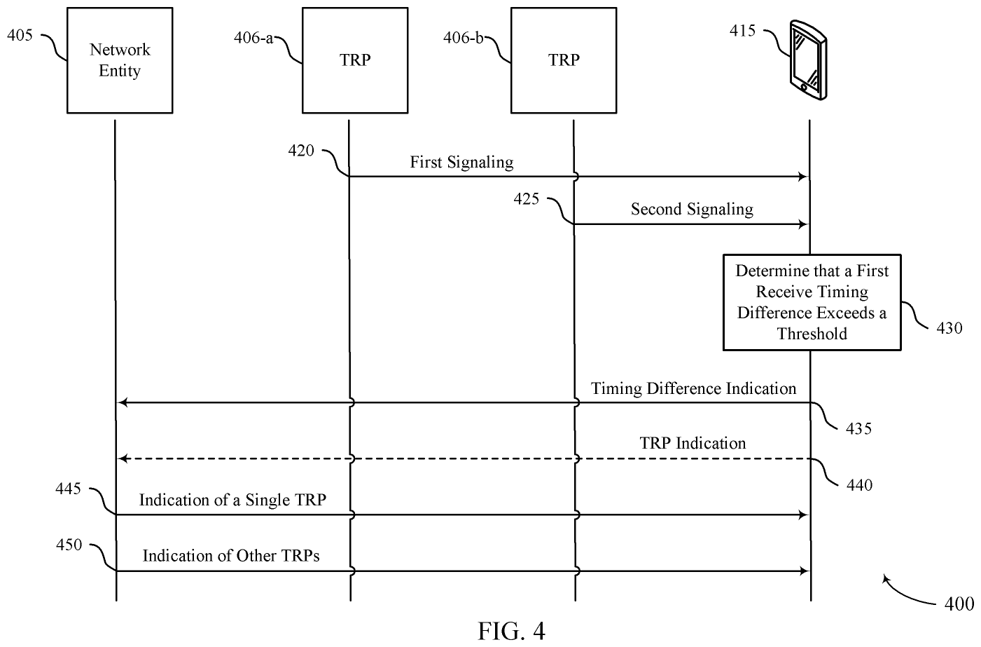

FIG. 4 illustrates an example of a process flow 400 that supports receive timing difference reporting for multi-TRP operation in accordance with one or more aspects of the present disclosure. The process flow 400 may implement or be implemented by one or more aspects of the wireless communications system 100 and the wireless communications system 200. For example, the process flow 400 may include a UE 415 and a network entity 405, which may be examples of the corresponding devices as described with reference to FIGS. 1 and 2. The process flow 400 may also include one or more TRPs 406 (e.g., a TRP 406-a and a TRP 406-b), which may be an example of the corresponding devices as described with reference to FIGS. 1 and 2. In the example of FIG. 4, the TRP 406-a and the TRP 406-b may each be examples of an RU 170 (or one or more other components of the network entity 405) as described with reference to FIG. 1. In the following description of the process flow 400, operations between the UE 415, the network entity 405, and the TRPs 406 may occur in a different order or at different times than as shown. Some operations may also be omitted from the process flow 400, and other operations may be added to the process flow 400.

As illustrated in the example of FIG. 4, a wireless communications system may support multi-TRP operations, in which the UE 415 may simultaneously communicate with the TRP 406-a and the TRP 406-b. In some examples, to improve synchronization reliability within the wireless communications system, the UE 415 may determine whether a receive timing difference associated with the TRP 406-a and the TRP 406-b (e.g., such as receive timing difference 310 with reference to FIG. 3) exceeds a threshold. In some examples, the threshold may be an example of a threshold timing difference as described with reference to FIGS. 2 and 3. In some examples, the UE 415 may determine a receive timing for each TRP 406 based on signaling received at the UE 415 (e.g., from each TRP 406). For example, at 420, the UE 415 may receive first signaling from the TRP 406-a and, at 425, the UE 415 may receive second signaling from the TRP 406-b. In some examples, the TRP 406-a and the TRP 406-b may both be associated with (e.g., served by, controlled by) the network entity 405. While the example of FIG. 4 illustrates the first signaling and the second signaling being received by the UE 415 in an order (e.g., at 420 and 425, respectively) it is to be understood that the first signaling may be received at the UE 415 before the second signaling, at a same times as the second signaling (e.g., the first signaling and the second signaling may be received simultaneously), or subsequent to the second signaling.

At 430, the UE 415 may determine that a first receive timing difference exceeds a threshold (e.g., the threshold timing difference). For example, the UE 415 may determine that a first receive timing difference between a first receive timing for the first signaling (e.g., received from the TRP 406-a at 420) and a second receive timing for the second signaling (e.g., received from the TRP 406-b at 425) exceeds the threshold timing difference.

In some examples, the UE 415 may transmit, to the network entity 405 (e.g., and based on the determination at 430) a first message indicating that the first receive timing difference between the first receive timing and the second receive timing exceeds the threshold. For example, at 435, the UE 415 may transmit a timing difference indication (e.g., a first message) to the network entity 405. In some examples, the UE 415 may transmit, to the network entity 405 (e.g., and based on the first receive timing difference between the first receive timing and the second receive timing exceeding the threshold), a third message indicating two (or more) candidate TRPs. For example, at 435 the UE 415 may transmit a timing difference indication to the network entity 405. In some examples, the two (or more) candidate TPRs in indicated to the network entity 405 (e.g., via the timing difference indication transmitted at 435) may be examples of candidate TRPs as described with reference to FIG. 3. For example, a receive timing difference associated with signaling from the two (or more) candidate TRPs may not exceed (e.g., may be less than or equal) to the threshold timing difference.

In some examples, the UE 415 may receive, from the network entity 405 and in response to the timing difference indication transmitted at 435, a second message indicating for the UE 415 to perform wireless communications with a single TRP. For example, at 445, the UE 415 may receive an indication of a single TRP from the network entity 405. Additionally, or alternatively, the UE 415 may receive, from the network entity 405 and in response to the third message, a fourth message indicating other TRPs (e.g., a third TRP and a fourth TRP). For example, at 450, the UE 415 may receive an indication of other TRPs from the network entity 405. In some examples, the other TRPs (e.g., indicated to the UE 415 at 450) may correspond to (e.g., be) candidate TRPs indicate to the network (e.g., via the TRP indication transmitted by the UE 415 at 440). In some examples, by transmitting the timing difference indication to the network entity 405 (e.g., at 435), the UE 415 may reduce network inefficiencies, among other possible benefits.

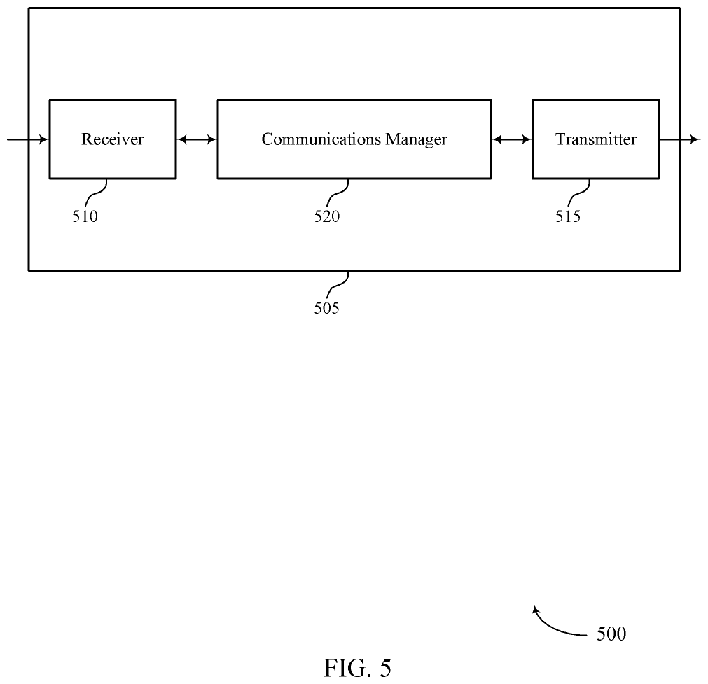

FIG. 5 shows a block diagram 500 of a device 505 that supports receive timing difference reporting for multi-TRP operation in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to receive timing difference reporting for multi-TRP operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to receive timing difference reporting for multi-TRP operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of receive timing difference reporting for multi-TRP operation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE (e.g., the device 505) in accordance with examples as disclosed herein. For example, the communications manager 520 may be configured as or otherwise support a means for receiving first signaling from a first TRP and second signaling from a second TRP, the first TRP and the second TRP both associated with a network entity. The communications manager 520 may be configured as or otherwise support a means for determining that a first receive timing difference between a first receive timing for the first signaling from the first TRP and a second receive timing for the second signaling from the second TRP exceeds a threshold. The communications manager 520 may be configured as or otherwise support a means for transmitting, to the network entity and based on the determining, a message indicating that the first receive timing difference between the first receive timing and the second receive timing exceeds the threshold. The communications manager 520 may be configured as or otherwise support a means for receiving, from the network entity and in response to the first message, a second message indicating for the UE to perform wireless communications with a single TRP or with two TRPs associated with a second receive timing difference at the UE that is less than or equal to the threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing and more efficient utilization of communication resources.

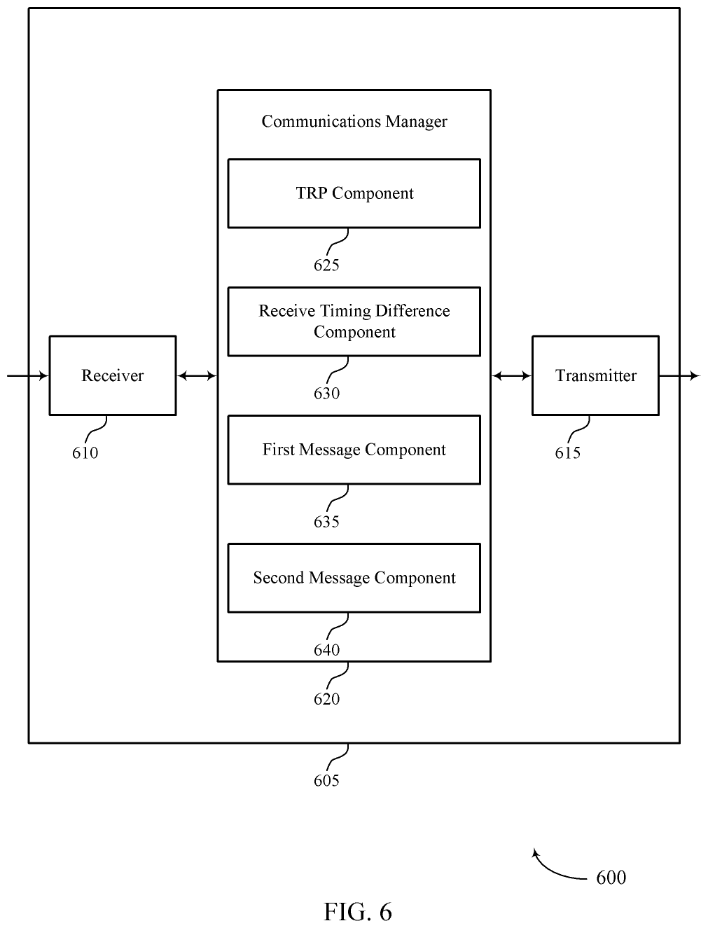

FIG. 6 shows a block diagram 600 of a device 605 that supports receive timing difference reporting for multi-TRP operation in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to receive timing difference reporting for multi-TRP operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to receive timing difference reporting for multi-TRP operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of receive timing difference reporting for multi-TRP operation as described herein. For example, the communications manager 620 may include an TRP component 625, a receive timing difference component 630, a first message component 635, a second message component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. The TRP component 625 may be configured as or otherwise support a means for receiving first signaling from a first TRP and second signaling from a second TRP, the first TRP and the second TRP both associated with a network entity. The receive timing difference component 630 may be configured as or otherwise support a means for determining that a first receive timing difference between a first receive timing for the first signaling from the first TRP and a second receive timing for the second signaling from the second TRP exceeds a threshold. The first message component 635 may be configured as or otherwise support a means for transmitting, to the network entity and based on the determining, a first message indicating that the first receive timing difference between the first receive timing and the second receive timing exceeds the threshold. The second message component 640 may be configured as or otherwise support a means for receiving, from the network entity and in response to the first message, a second message indicating for the UE to perform wireless communications with a single TRP or with two TRPs associated with a second receive timing difference at the UE that is less than or equal to the threshold.

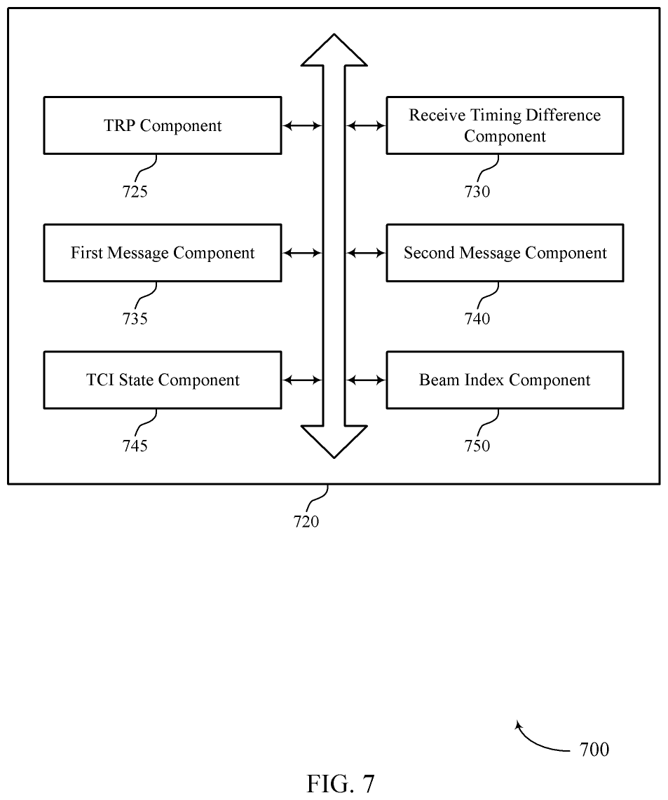

FIG. 7 shows a block diagram 700 of a communications manager 720 that supports receive timing difference reporting for multi-TRP operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of receive timing difference reporting for multi-TRP operation as described herein. For example, the communications manager 720 may include an TRP component 725, a receive timing difference component 730, a first message component 735, a second message component 740, a TCI state component 745, a beam index component 750, or any combination thereof. Each of these components may communicate, directly or indirectly, with one another (e.g., via one or more buses).

The communications manager 720 may support wireless communication at a UE in accordance with examples as disclosed herein. The TRP component 725 may be configured as or otherwise support a means for receiving first signaling from a first TRP and second signaling from a second TRP, the first TRP and the second TRP both associated with a network entity. The receive timing difference component 730 may be configured as or otherwise support a means for determining that a first receive timing difference between a first receive timing for the first signaling from the first TRP and a second receive timing for the second signaling from the second TRP exceeds a threshold. The first message component 735 may be configured as or otherwise support a means for transmitting, to the network entity and based on the determining, a first message indicating that the first receive timing difference between the first receive timing and the second receive timing exceeds the threshold. The second message component 740 may be configured as or otherwise support a means for receiving, from the network entity and in response to the first message, a second message indicating for the UE to perform wireless communications with a single TRP or with two TRPs associated with a second receive timing difference at the UE that is less than or equal to the threshold.

In some examples, the TCI state component 745 may be configured as or otherwise support a means for receiving, from the network entity, a transmission configuration message indicating a first TCI state and a second TCI state, where the first TRP is associated with the first TCI state and the second TRP is associated with the second TCI state, and where receiving the first signaling from the first TRP and the second signaling from the second TRP is based on the transmission configuration message.

In some examples, to support receiving the first signaling from the first TRP and the second signaling from the second TRP, the TCI state component 745 may be configured as or otherwise support a means for receiving the first signaling from the first TRP via a first beam corresponding to the first TCI state and the second signaling from the second TRP via a second beam corresponding to the second TCI state.

In some examples, to support receiving the first signaling from the first TRP and the second signaling from the second TRP, the beam index component 750 may be configured as or otherwise support a means for receiving the first signaling from the first TRP via a first beam associated with a first beam index and the second signaling from the second TRP via a second beam associated with a second beam index.

In some examples, the first beam and the second beam correspond to a beam combination of a set of multiple beam combinations for receiving signaling from a plurality TRPs. In some examples, the first receive timing difference between the first receive timing and the second receive timing corresponds to a maximum receive timing difference of a set of multiple receive timing differences determined for the set of multiple beam combinations. In some examples, the first signaling and the second signaling include respective SSBs.

In some examples, the first receive timing for the first signaling corresponds to a first time at which the first signaling is received at the UE and the second receive timing for the second signaling corresponds to a second time at which the second signaling is received at the UE. In some examples, the first TRP and the second TRP are associated with a same TAG. In some examples, the first TRP is associated with a first TAG and the second TRP is associated with a second TAG.

In some examples, the first receive timing for the first signaling is based on a downlink frame timing of the first TAG and the second receive timing for the second signaling is based on a downlink frame timing of the second TAG. In some examples, the first receive timing is based on a slot timing of the first TAG and the second receive timing for the second signaling is based on a slot timing of the second TAG.

In some examples, the receive timing difference component 730 may be configured as or otherwise support a means for transmitting, to the network entity and based on the first receive timing difference between the first receive timing and the second receive timing exceeding the threshold, a third message indicating at least two candidate TRPs, where a receive timing difference associated with signaling from the at least two candidate TRPs is less than or equal to the threshold.

In some examples, the second message indicates for the UE to perform the wireless communications with the two TRPs, and the at least two candidate TRPs include the two TRPs. In some examples, the at least two candidate TRPs are indicated by at least two TCI state groups, at least two sets of SSB indices, at least two CORESET pool indices, at least two PCIs, or any combination thereof. In some examples, the second message indicates for the UE to perform wireless communications with the single TRP.

In some examples, the first message is transmitted in accordance with a periodicity or based on determining that the first receive timing difference between the first receive timing and the second receive timing exceeds the threshold. In some examples, the first message includes uplink control information, a MAC-CE, or an RLC message. In some examples, the threshold is based on a subcarrier spacing or a radio frequency band configured for the UE.

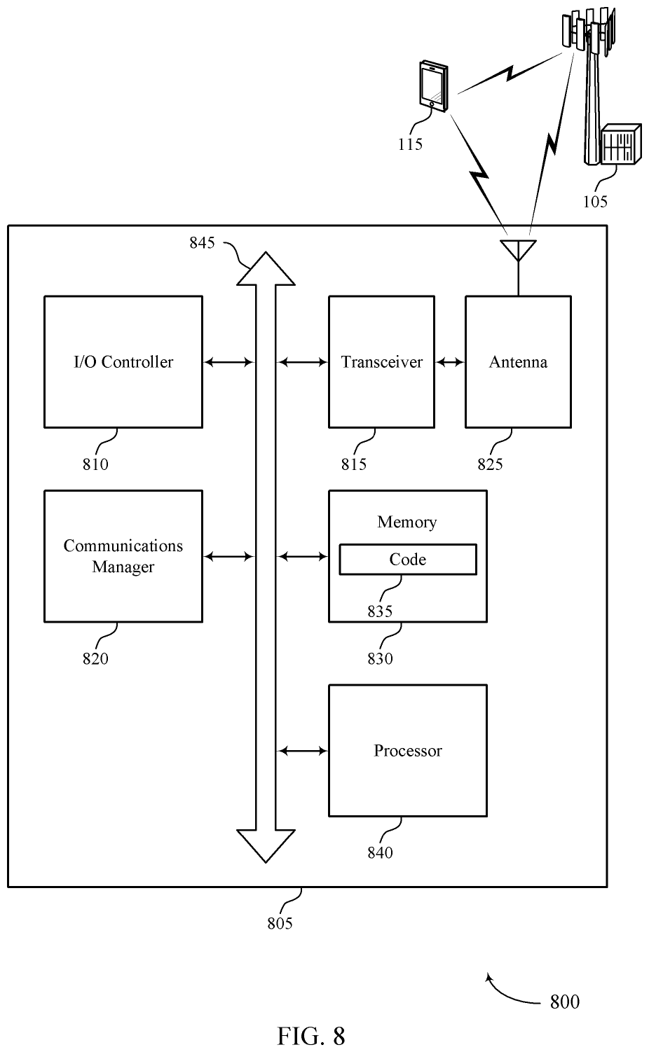

FIG. 8 shows a diagram of a system 800 including a device 805 that supports receive timing difference reporting for multi-TRP operation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting receive timing difference reporting for multi-TRP operation). For example, the device 805 or a component of the device 805 may include a processor 840 and memory 830 coupled with or to the processor 840, the processor 840 and memory 830 configured to perform various functions described herein.

The communications manager 820 may support wireless communication at a UE (e.g., the device 805) in accordance with examples as disclosed herein. For example, the communications manager 820 may be configured as or otherwise support a means for receiving first signaling from a first TRP and second signaling from a second TRP, the first TRP and the second TRP both associated with a network entity. The communications manager 820 may be configured as or otherwise support a means for determining that a first receive timing difference between a first receive timing for the first signaling from the first TRP and a second receive timing for the second signaling from the second TRP exceeds a threshold. The communications manager 820 may be configured as or otherwise support a means for transmitting, to the network entity and based on the determining, a first message indicating that the first receive timing difference between the first receive timing and the second receive timing exceeds the threshold. The communications manager 820 may be configured as or otherwise support a means for receiving, from the network entity and in response to the first message, a second message indicating for the UE to perform wireless communications with a single TRP or with two TRPs associated with a second receive timing difference at the UE that is less than or equal to the threshold.

By including or configuring the communications manager 820 in accordance with examples as described herein, the device 805 may support techniques for improved communication reliability, reduced latency, improved user experience related to reduced processing, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of receive timing difference reporting for multi-TRP operation as described herein, or the processor 840 and the memory 830 may be otherwise configured to perform or support such operations.

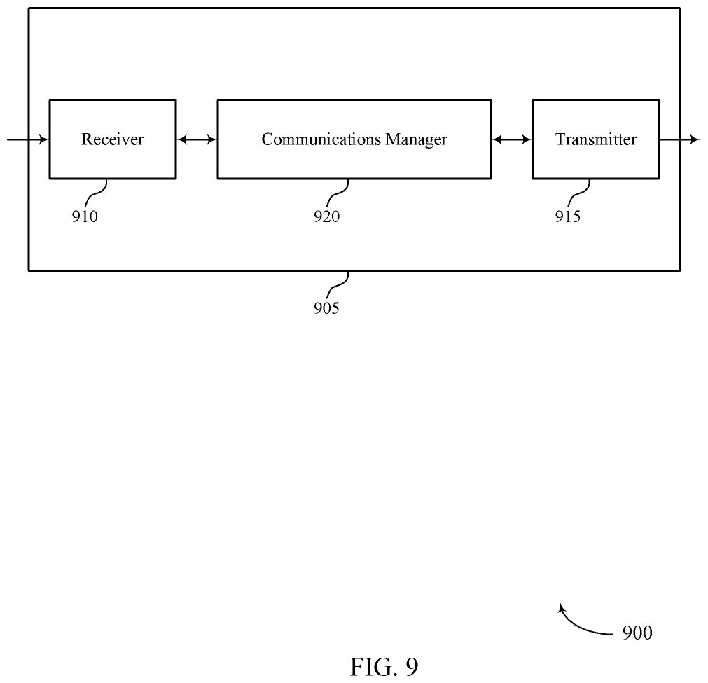

FIG. 9 shows a block diagram 900 of a device 905 that supports receive timing difference reporting for multi-TRP operation in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of receive timing difference reporting for multi-TRP operation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity (e.g., the device 905) in accordance with examples as disclosed herein. For example, the communications manager 920 may be configured as or otherwise support a means for obtaining a first message indicating that a first receive timing difference at a UE between a first receive timing for first signaling from a first TRP associated with the network entity and a second receive timing for second signaling from a second TRP associated with the network entity exceeds a threshold. The communications manager 920 may be configured as or otherwise support a means for outputting a second message indicating for the UE to perform wireless communications with a single TRP or with two TRPs associated with a second receive timing difference at the UE that is less than or equal to the threshold.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and more efficient utilization of communication resources.

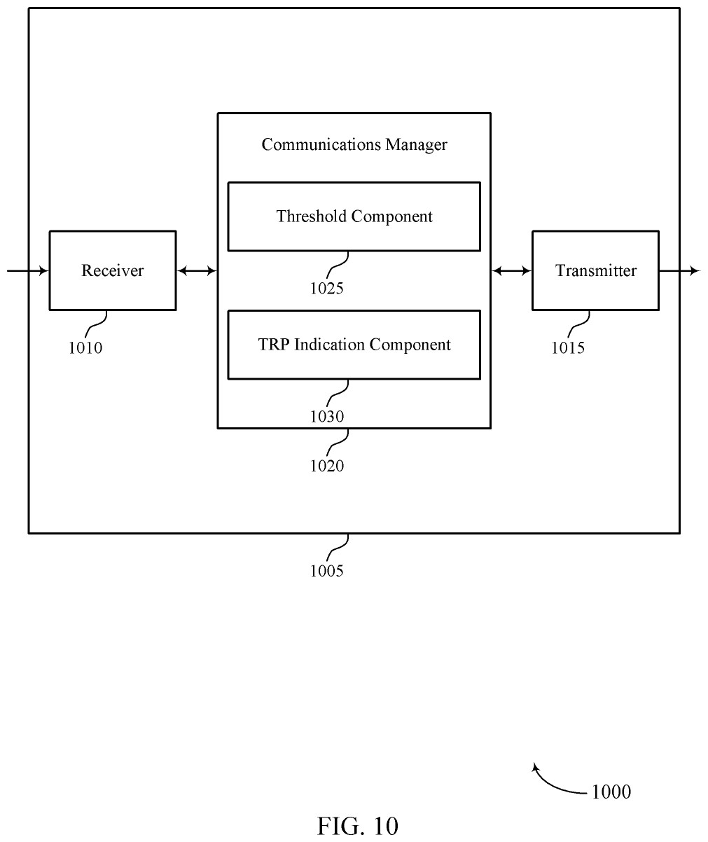

FIG. 10 shows a block diagram 1000 of a device 1005 that supports receive timing difference reporting for multi-TRP operation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of receive timing difference reporting for multi-TRP operation as described herein. For example, the communications manager 1020 may include a threshold component 1025 an TRP indication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. The threshold component 1025 may be configured as or otherwise support a means for obtaining a first message indicating that a first receive timing difference at a UE between a first receive timing for first signaling from a first TRP associated with the network entity and a second receive timing for second signaling from a second TRP associated with the network entity exceeds a threshold. The TRP indication component 1030 may be configured as or otherwise support a means for outputting a second message indicating for the UE to perform wireless communications with a single TRP or with two TRPs associated with a second receive timing difference at the UE that is less than or equal to the threshold.

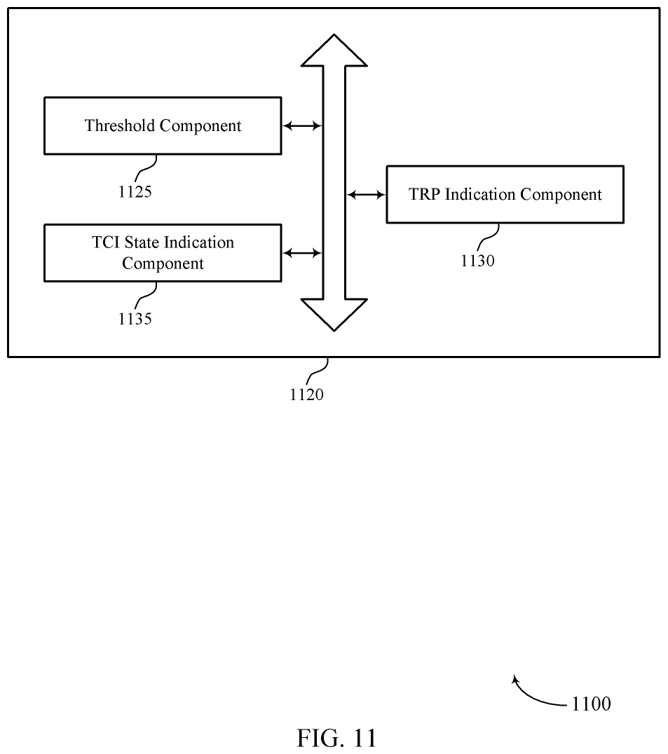

FIG. 11 shows a block diagram 1100 of a communications manager 1120 that supports receive timing difference reporting for multi-TRP operation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of receive timing difference reporting for multi-TRP operation as described herein. For example, the communications manager 1120 may include a threshold component 1125, an TRP indication component 1130, a TCI state indication component 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The threshold component 1125 may be configured as or otherwise support a means for obtaining a first message indicating that a first receive timing difference at a UE between a first receive timing for first signaling from a first TRP associated with the network entity and a second receive timing for second signaling from a second TRP associated with the network entity exceeds a threshold. The TRP indication component 1130 may be configured as or otherwise support a means for outputting a second message indicating for the UE to perform wireless communications with a single TRP or with two TRPs associated with a second receive timing difference at the UE that is less than or equal to the threshold.

In some examples, the TCI state indication component 1135 may be configured as or otherwise support a means for outputting a transmission configuration message indicating a set of multiple TCI states, where the first TRP is associated with a first TCI state of the set of multiple TCI states and the second TRP is associated with a second TCI state of the set of multiple TCI states.

In some examples, the first receive timing corresponds to a first time at which the first signaling is received at the UE from the first TRP and the second receive timing corresponds to a second time at which the second signaling is received at the UE from the second TRP. In some examples, the first TRP and the second TRP are associated with a same TAG. In some examples, the first TRP is associated with a first TAG and the second TRP is associated with a second TAG.

In some examples, the threshold component 1125 may be configured as or otherwise support a means for obtaining a third message indicating at least two candidate TRPs, where a receive timing difference associated with signaling from the at least two candidate TRPs is less than or equal to the threshold, and where outputting the second message is based on obtaining the third message.

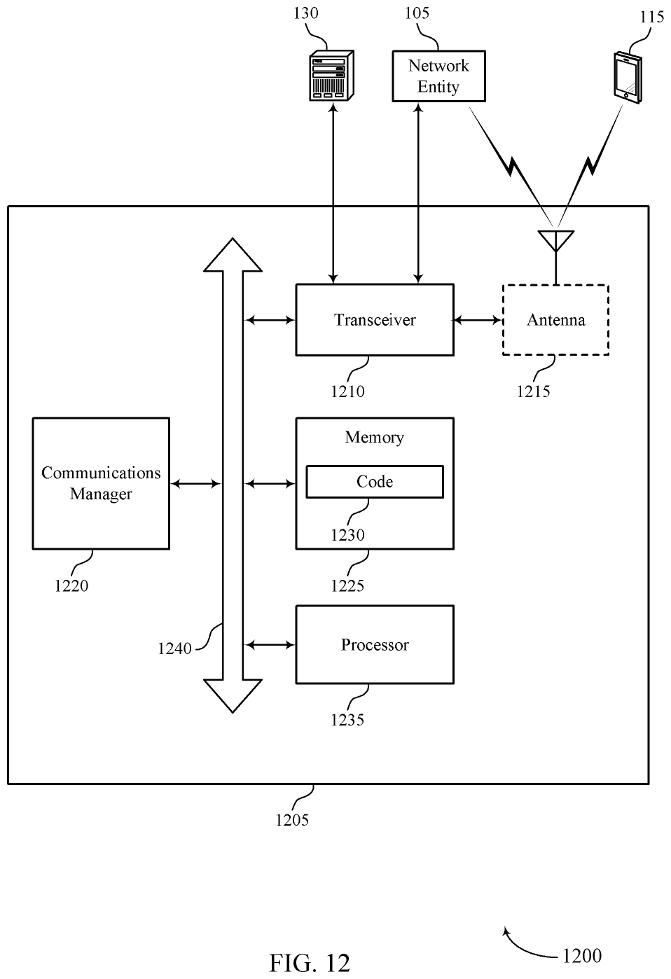

FIG. 12 shows a diagram of a system 1200 including a device 1205 that supports receive timing difference reporting for multi-TRP operation in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting receive timing difference reporting for multi-TRP operation). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity (e.g., the device 1205) in accordance with examples as disclosed herein. For example, the communications manager 1220 may be configured as or otherwise support a means for obtaining a first message indicating that a first receive timing difference at a UE between a first receive timing for first signaling from a first TRP associated with the network entity and a second receive timing for second signaling from a second TRP associated with the network entity exceeds a threshold. The communications manager 1220 may be configured as or otherwise support a means for outputting a second message indicating for the UE to perform wireless communications with a single TRP or with two TRPs associated with a second receive timing difference at the UE that is less than or equal to the threshold.

By including or configuring the communications manager 1220 in accordance with examples as described herein, the device 1205 may support techniques for improved communication reliability, reduced latency, improved user experience related to reduced processing, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of receive timing difference reporting for multi-TRP operation as described herein, or the processor 1235 and the memory 1225 may be otherwise configured to perform or support such operations.

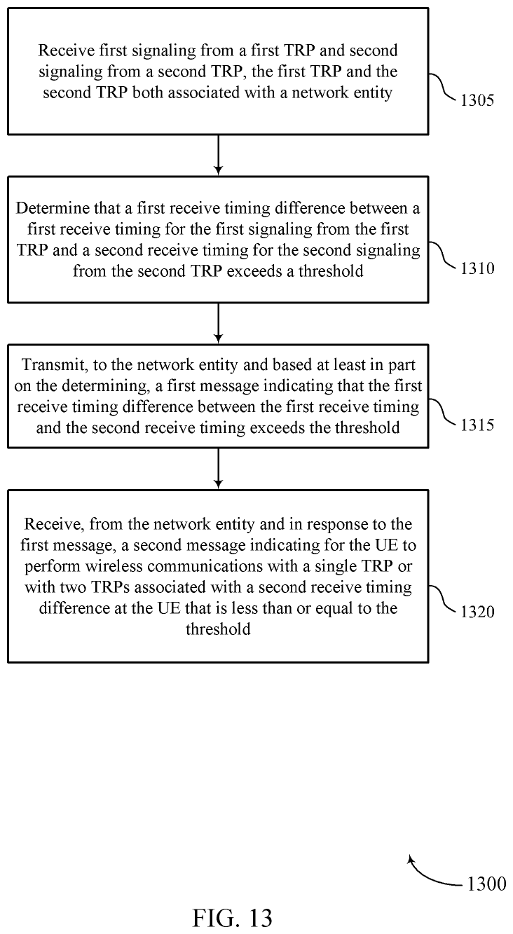

FIG. 13 shows a flowchart illustrating a method 1300 that supports receive timing difference reporting for multi-TRP operation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first signaling from a first TRP and second signaling from a second TRP, the first TRP and the second TRP both associated with a network entity. The operations of 1305 may be performed in accordance with examples as disclosed herein, for example, in accordance with 420 and 425 with reference to FIG. 4. In some examples, aspects of the operations of 1305 may be performed by an TRP component 725 as described with reference to FIG. 7. Additionally, or alternatively, means for performing 1305 may, but not necessarily, include, for example, antenna 825, transceiver 815, communications manager 820, memory 830 (including code 835), processor 840 and/or bus 845.

At 1310, the method may include determining that a first receive timing difference between a first receive timing for the first signaling from the first TRP and a second receive timing for the second signaling from the second TRP exceeds a threshold. The operations of 1310 may be performed in accordance with examples as disclosed herein, for example, in accordance with 430 with reference to FIG. 4. In some examples, aspects of the operations of 1310 may be performed by a receive timing difference component 730 as described with reference to FIG. 7. Additionally, or alternatively, means for performing 1310 may, but not necessarily, include, for example, antenna 825, transceiver 815, communications manager 820, memory 830 (including code 835), processor 840 and/or bus 845.

At 1315, the method may include transmitting, to the network entity and based on the determining, a first message indicating that the first receive timing difference between the first receive timing and the second receive timing exceeds the threshold. The operations of 1315 may be performed in accordance with examples as disclosed herein, for example, in accordance with 435 with reference to FIG. 4. In some examples, aspects of the operations of 1315 may be performed by a first message component 735 as described with reference to FIG. 7. Additionally, or alternatively, means for performing 1315 may, but not necessarily, include, for example, antenna 825, transceiver 815, communications manager 820, memory 830 (including code 835), processor 840 and/or bus 845.

At 1320, the method may include receiving, from the network entity and in response to the first message, a second message indicating for the UE to perform wireless communications with a single TRP or with two TRPs associated with a second receive timing difference at the UE that is less than or equal to the threshold. The operations of 1320 may be performed in accordance with examples as disclosed herein, for example, in accordance with 445 and 450 with reference to FIG. 4. In some examples, aspects of the operations of 1320 may be performed by a second message component 740 as described with reference to FIG. 7. Additionally, or alternatively, means for performing 1320 may, but not necessarily, include, for example, antenna 825, transceiver 815, communications manager 820, memory 830 (including code 835), processor 840 and/or bus 845.

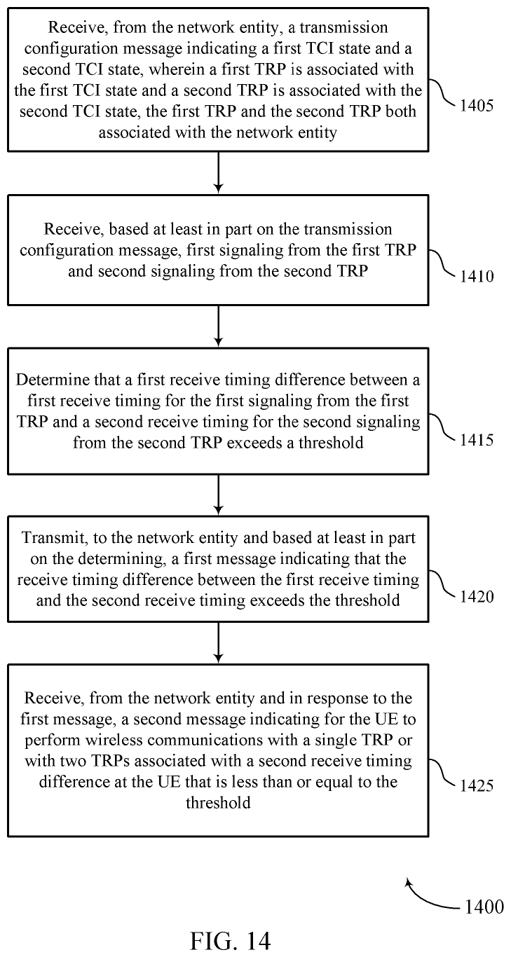

FIG. 14 shows a flowchart illustrating a method 1400 that supports receive timing difference reporting for multi-TRP operation in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a transmission configuration message indicating a first TCI state and a second TCI state, where a first TRP is associated with the first TCI state and a second TRP is associated with the second TCI state, the first TRP and the second TRP both associated with the network entity. The operations of 1405 may be performed in accordance with examples as disclosed herein. In some examples, aspects of the operations of 1405 may be performed by an TRP component 725 as described with reference to FIG. 7. Additionally, or alternatively, means for performing 1405 may, but not necessarily, include, for example, antenna 825, transceiver 815, communications manager 820, memory 830 (including code 835), processor 840 and/or bus 845.

At 1410, the method may include receiving, based on the transmission configuration message, first signaling from the first TRP and the second signaling from the second TRP. The operations of 1410 may be performed in accordance with examples as disclosed herein, for example, in accordance with 420 and 425 with reference to FIG. 4. In some examples, aspects of the operations of 1410 may be performed by a TCI state component 745 as described with reference to FIG. 7. Additionally, or alternatively, means for performing 1410 may, but not necessarily, include, for example, antenna 825, transceiver 815, communications manager 820, memory 830 (including code 835), processor 840 and/or bus 845.

At 1415, the method may include determining that a first receive timing difference between a first receive timing for the first signaling from the first TRP and a second receive timing for the second signaling from the second TRP exceeds a threshold. The operations of 1415 may be performed in accordance with examples as disclosed herein, for example, in accordance with 430 with reference to FIG. 4. In some examples, aspects of the operations of 1415 may be performed by a receive timing difference component 730 as described with reference to FIG. 7. Additionally, or alternatively, means for performing 1415 may, but not necessarily, include, for example, antenna 825, transceiver 815, communications manager 820, memory 830 (including code 835), processor 840 and/or bus 845.

At 1420, the method may include transmitting, to the network entity and based on the determining, a first message indicating that the first receive timing difference between the first receive timing and the second receive timing exceeds the threshold. The operations of 1420 may be performed in accordance with examples as disclosed herein, for example, in accordance with 435 with reference to FIG. 4. In some examples, aspects of the operations of 1420 may be performed by a first message component 735 as described with reference to FIG. 7. Additionally, or alternatively, means for performing 1420 may, but not necessarily, include, for example, antenna 825, transceiver 815, communications manager 820, memory 830 (including code 835), processor 840 and/or bus 845.

At 1425, the method may include receiving, from the network entity and in response to the first message, a second message indicating for the UE to perform wireless communications with a single TRP or with two TRPs associated with a second receive timing difference at the UE that is less than or equal to the threshold. The operations of 1425 may be performed in accordance with examples as disclosed herein, for example, in accordance with 445 and 450 with reference to FIG. 4. In some examples, aspects of the operations of 1425 may be performed by a second message component 740 as described with reference to FIG. 7. Additionally, or alternatively, means for performing 1425 may, but not necessarily, include, for example, antenna 825, transceiver 815, communications manager 820, memory 830 (including code 835), processor 840 and/or bus 845.

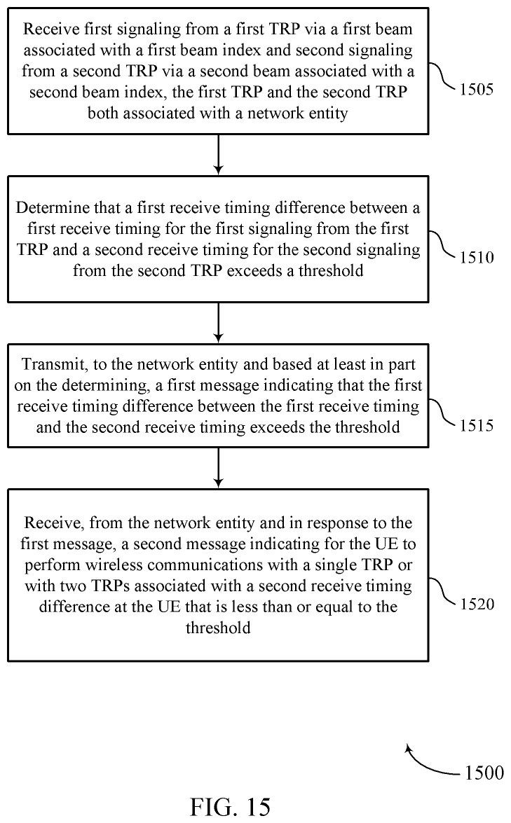

FIG. 15 shows a flowchart illustrating a method 1500 that supports receive timing difference reporting for multi-TRP operation in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving first signaling from the first TRP via a first beam associated with a first beam index and second signaling from the second TRP via a second beam associated with a second beam index, the first TRP and the second TRP both associated with a network entity. The operations of 1505 may be performed in accordance with examples as disclosed herein, for example, in accordance with 420 and 425 with reference to FIG. 4. In some examples, aspects of the operations of 1505 may be performed by a beam index component 750 as described with reference to FIG. 7. Additionally, or alternatively, means for performing 1505 may, but not necessarily, include, for example, antenna 825, transceiver 815, communications manager 820, memory 830 (including code 835), processor 840 and/or bus 845.

At 1510, the method may include determining that a first receive timing difference between a first receive timing for the first signaling from the first TRP and a second receive timing for the second signaling from the second TRP exceeds a threshold. The operations of 1510 may be performed in accordance with examples as disclosed herein, for example, in accordance with 430 with reference to FIG. 4. In some examples, aspects of the operations of 1510 may be performed by a receive timing difference component 730 as described with reference to FIG. 7. Additionally, or alternatively, means for performing 1510 may, but not necessarily, include, for example, antenna 825, transceiver 815, communications manager 820, memory 830 (including code 835), processor 840 and/or bus 845.

At 1515, the method may include transmitting, to the network entity and based on the determining, a first message indicating that the first receive timing difference between the first receive timing and the second receive timing exceeds the threshold. The operations of 1515 may be performed in accordance with examples as disclosed herein, for example, in accordance with 435 with reference to FIG. 4. In some examples, aspects of the operations of 1515 may be performed by a first message component 735 as described with reference to FIG. 7. Additionally, or alternatively, means for performing 1515 may, but not necessarily, include, for example, antenna 825, transceiver 815, communications manager 820, memory 830 (including code 835), processor 840 and/or bus 845.

At 1520, the method may include receiving, from the network entity and in response to the first message, a second message indicating for the UE to perform wireless communications with a single TRP or with two TRPs associated with a second receive timing difference at the UE that is less than or equal to the threshold. The operations of 1520 may be performed in accordance with examples as disclosed herein, for example, in accordance with 445 and 450 with reference to FIG. 4. In some examples, aspects of the operations of 1520 may be performed by a second message component 740 as described with reference to FIG. 7. Additionally, or alternatively, means for performing 1520 may, but not necessarily, include, for example, antenna 825, transceiver 815, communications manager 820, memory 830 (including code 835), processor 840 and/or bus 845.

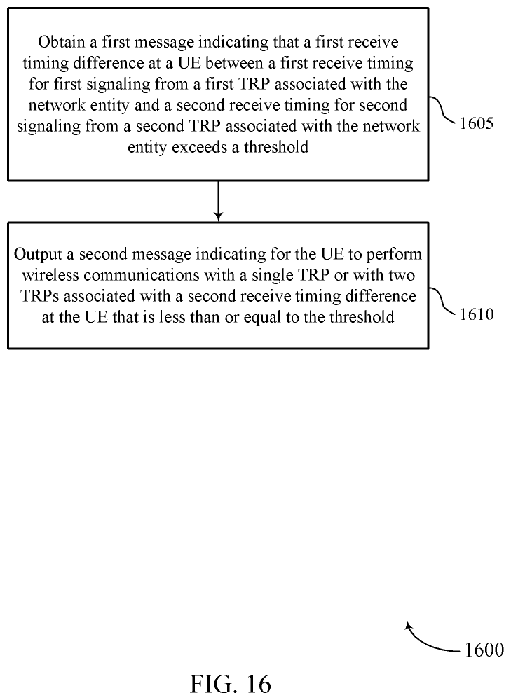

FIG. 16 shows a flowchart illustrating a method 1600 that supports receive timing difference reporting for multi-TRP operation in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a first message indicating that a first receive timing difference at a UE between a first receive timing for first signaling from a first TRP associated with the network entity and a second receive timing for second signaling from a second TRP associated with the network entity exceeds a threshold. The operations of 1605 may be performed in accordance with examples as disclosed herein, for example, in accordance with 435 with reference to FIG. 4. In some examples, aspects of the operations of 1605 may be performed by a threshold component 1125 as described with reference to FIG. 11. Additionally, or alternatively, means for performing 1605 may, but not necessarily, include, for example, antenna 1215, transceiver 1210, communications manager 1220, memory 1225 (including code 1230), processor 1235 and/or bus 1240.

At 1610, the method may include outputting a second message indicating for the UE to perform wireless communications with a single TRP or with two TRPs associated with a second receive timing difference at the UE that is less than or equal to the threshold. The operations of 1610 may be performed in accordance with examples as disclosed herein, for example, in accordance with 445 and 450 with reference to FIG. 4. In some examples, aspects of the operations of 1610 may be performed by an TRP indication component 1130 as described with reference to FIG. 11. Additionally, or alternatively, means for performing 1610 may, but not necessarily, include, for example, antenna 1215, transceiver 1210, communications manager 1220, memory 1225 (including code 1230), processor 1235 and/or bus 1240.

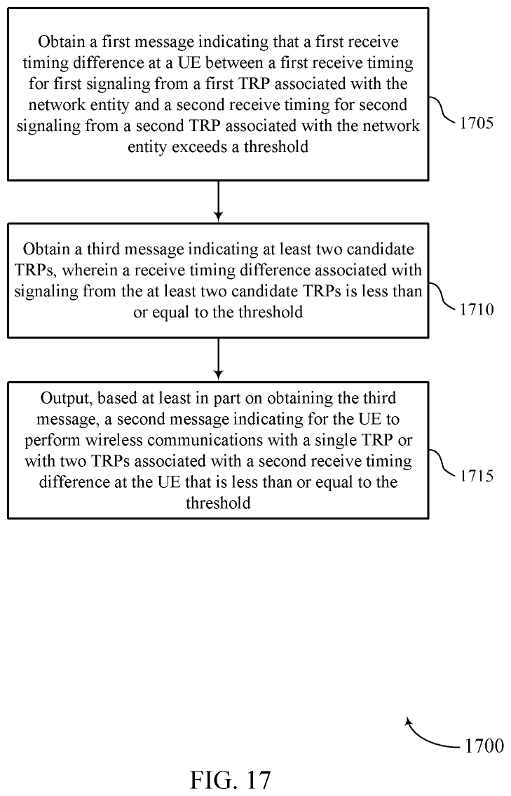

FIG. 17 shows a flowchart illustrating a method 1700 that supports receive timing difference reporting for multi-TRP operation in accordance with one or more aspects of the present disclosure. The operations of the method 1700 may be implemented by a network entity or its components as described herein, for example, in accordance with 420 and 425 with reference to FIG. 4. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include obtaining a first message indicating that a first receive timing difference at a UE between a first receive timing for first signaling from a first TRP associated with the network entity and a second receive timing for second signaling from a second TRP associated with the network entity exceeds a threshold. The operations of 1705 may be performed in accordance with examples as disclosed herein, for example, in accordance with 435 with reference to FIG. 4. In some examples, aspects of the operations of 1705 may be performed by a threshold component 1125 as described with reference to FIG. 11. Additionally, or alternatively, means for performing 1705 may, but not necessarily, include, for example, antenna 1215, transceiver 1210, communications manager 1220, memory 1225 (including code 1230), processor 1235 and/or bus 1240.

At 1710, the method may include obtaining a third message indicating at least two candidate TRPs, where a receive timing difference associated with signaling from the at least two candidate TRPs is less than or equal to the threshold. The operations of 1710 may be performed in accordance with examples as disclosed herein, for example, in accordance with 440 with reference to FIG. 4. In some examples, aspects of the operations of 1710 may be performed by a threshold component 1125 as described with reference to FIG. 11. Additionally, or alternatively, means for performing 1710 may, but not necessarily, include, for example, antenna 1215, transceiver 1210, communications manager 1220, memory 1225 (including code 1230), processor 1235 and/or bus 1240.

At 1715, the method may include outputting, based on obtaining the third message, a second message indicating for the UE to perform wireless communications with a single TRP or with two TRPs associated with a second receive timing difference at the UE that is less than or equal to the threshold. The operations of 1715 may be performed in accordance with examples as disclosed herein, for example, in accordance with 445 and 450 with reference to FIG. 4. In some examples, aspects of the operations of 1715 may be performed by an TRP indication component 1130 as described with reference to FIG. 11. Additionally, or alternatively, means for performing 1715 may, but not necessarily, include, for example, antenna 1215, transceiver 1210, communications manager 1220, memory 1225 (including code 1230), processor 1235 and/or bus 1240.

The following provides an overview of aspects of the present disclosure:

Aspect 1: A method for wireless communication at a UE, comprising: receiving first signaling from a first TRP and second signaling from a second TRP, the first TRP and the second TRP both associated with a network entity; determining that a first receive timing difference between a first receive timing for the first signaling from the first TRP and a second receive timing for the second signaling from the second TRP exceeds a threshold; transmitting, to the network entity and based at least in part on the determining, a first message indicating that the first receive timing difference between the first receive timing and the second receive timing exceeds the threshold; and receiving, from the network entity and in response to the first message, a second message indicating for the UE to perform wireless communications with a single TRP or with two TRPs associated with a second receive timing difference at the UE that is less than or equal to the threshold.

Aspect 2: The method of aspect 1, further comprising: receiving, from the network entity, a transmission configuration message indicating a first TCI state and a second TCI state, wherein the first TRP is associated with the first TCI state and the second TRP is associated with the second TCI state, and wherein receiving the first signaling from the first TRP and the second signaling from the second TRP is based at least in part on the transmission configuration message.

Aspect 3: The method of aspect 2, wherein receiving the first signaling from the first TRP and the second signaling from the second TRP comprises: receiving the first signaling from the first TRP via a first beam corresponding to the first TCI state and the second signaling from the second TRP via a second beam corresponding to the second TCI state.

Aspect 4: The method of aspect 1, wherein receiving the first signaling from the first TRP and the second signaling from the second TRP comprises: receiving the first signaling from the first TRP via a first beam associated with a first beam index and the second signaling from the second TRP via a second beam associated with a second beam index.

Aspect 5: The method of aspect 4, wherein the first beam and the second beam correspond to a beam combination of a plurality of beam combinations for receiving signaling from a plurality TRPs, and the first receive timing difference between the first receive timing and the second receive timing corresponds to a maximum receive timing difference of a plurality of receive timing differences determined for the plurality of beam combinations.

Aspect 6: The method of any of aspects 4 through 5, wherein the first signaling and the second signaling comprise respective SSBs.

Aspect 7: The method of aspect 1, wherein the first receive timing for the first signaling corresponds to a first time at which the first signaling is received at the UE and the second receive timing for the second signaling corresponds to a second time at which the second signaling is received at the UE.

Aspect 8: The method of any of aspects 1 through 7, wherein the first TRP and the second TRP are associated with a same TAG.

Aspect 9: The method of aspect 1, wherein the first TRP is associated with a first TAG and the second TRP is associated with a second TAG.

Aspect 10: The method of aspect 9, wherein the first receive timing for the first signaling is based at least in part on a downlink frame timing of the first TAG and the second receive timing for the second signaling is based at least in part on a downlink frame timing of the second TAG.

Aspect 11: The method of aspect 9, wherein the first receive timing is based at least in part on a slot timing of the first TAG and the second receive timing for the second signaling is based at least in part on a slot timing of the second TAG.

Aspect 12: The method of any of aspects 1 through 11, further comprising: transmitting, to the network entity and based at least in part on the first receive timing difference between the first receive timing and the second receive timing exceeding the threshold, a third message indicating at least two candidate TRPs, wherein a receive timing difference associated with signaling from the at least two candidate TRPs is less than or equal to the threshold.

Aspect 13: The method of aspect 12, wherein the second message indicates for the UE to perform the wireless communications with the two TRPs, and the at least two candidate TRPs comprise the two TRPs.

Aspect 14: The method of any of aspects 12 through 13, wherein the at least two candidate TRPs are indicated by at least two TCI state groups, at least two sets of SSB indices, at least two CORESET pool indices, at least two PCIs, or any combination thereof.

Aspect 15: The method of any of aspects 1 through 11, wherein the second message indicates for the UE to perform wireless communications with the single TRP.

Aspect 16: The method of any of aspects 1 through 15, wherein the first message is transmitted in accordance with a periodicity or based at least in part on determining that the first receive timing difference between the first receive timing and the second receive timing exceeds the threshold.

Aspect 17: The method of any of aspects 1 through 16, wherein the first message comprises uplink control information, a MAC-CE, or an RLC message.

Aspect 18: The method of any of aspects 1 through 17, wherein the threshold is based at least in part on a subcarrier spacing or a radio frequency band configured for the UE.

Aspect 19: A method for wireless communication at a network entity, comprising: obtaining a first message indicating that a first receive timing difference at a UE between a first receive timing for first signaling from a first TRP associated with the network entity and a second receive timing for second signaling from a second TRP associated with the network entity exceeds a threshold; and outputting a second message indicating for the UE to perform wireless communications with a single TRP or with two TRPs associated with a second receive timing difference at the UE that is less than or equal to the threshold.

Aspect 20: The method of aspect 19, further comprising: outputting a transmission configuration message indicating a plurality of TCI states, wherein the first TRP is associated with a first TCI state of the plurality of TCI states and the second TRP is associated with a second TCI state of the plurality of TCI states.

Aspect 21: The method of aspect 20, wherein the first receive timing corresponds to a first time at which the first signaling is received at the UE from the first TRP and the second receive timing corresponds to a second time at which the second signaling is received at the UE from the second TRP.

Aspect 22: The method of any of aspects 19 through 21, wherein the first TRP and the second TRP are associated with a same TAG.

Aspect 23: The method of aspect 19, wherein the first TRP is associated with a first TAG and the second TRP is associated with a second TAG.

Aspect 24: The method of any of aspects 19 through 23, further comprising: obtaining a third message indicating at least two candidate TRPs, wherein a receive timing difference associated with signaling from the at least two candidate TRPs is less than or equal to the threshold, and wherein outputting the second message is based at least in part on obtaining the third message.

Aspect 25: An apparatus for wireless communication at a UE, comprising a memory, transceiver, and at least one processor coupled with the memory and the transceiver, the at least one processor configured to perform a method of any of aspects 1 through 18.

Aspect 26: An apparatus comprising at least one means for performing a method of any of aspects 1 through 18.

Aspect 27: A non-transitory computer-readable medium storing code for wireless communication at a UE, the code comprising instructions executable by a processor to perform a method of any of aspects 1 through 18.

Aspect 28: An apparatus comprising a memory and at least one processor coupled with the memory, the at least one processor configured to cause the apparatus to perform a method of any of aspects 19 through 24.

Aspect 29: An apparatus for wireless communication at a network entity, comprising at least one means for performing a method of any of aspects 19 through 24.

Aspect 30: A non-transitory computer-readable medium storing code for wireless communication at a network entity, the code comprising instructions executable by a processor to perform a method of any of aspects 19 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first signaling from a first transmission-reception point and second signaling from a second transmission-reception point, the first transmission-reception point and the second transmission-reception point both associated with a network entity;
determining that a first receive timing difference between a first receive timing for the first signaling from the first transmission-reception point and a second receive timing for the second signaling from the second transmission-reception point exceeds a threshold;
transmitting, to the network entity and based at least in part on the determining, a first message indicating that the first receive timing difference between the first receive timing and the second receive timing exceeds the threshold; and
receiving, from the network entity and in response to the first message, a second message indicating for the UE to perform wireless communications with a single transmission-reception point or with two transmission-reception points associated with a second receive timing difference at the UE that is less than or equal to the threshold.

2. The method of claim 1, further comprising:
receiving, from the network entity, a transmission configuration message indicating a first transmission configuration indicator state and a second transmission configuration indicator state, wherein the first transmission-reception point is associated with the first transmission configuration indicator state and the second transmission-reception point is associated with the second transmission configuration indicator state, and wherein receiving the first signaling from the first transmission-reception point and the second signaling from the second transmission-reception point is based at least in part on the transmission configuration message.

3. The method of claim 2, wherein receiving the first signaling from the first transmission-reception point and the second signaling from the second transmission-reception point comprises:
receiving the first signaling from the first transmission-reception point via a first beam corresponding to the first transmission configuration indicator state and the second signaling from the second transmission-reception point via a second beam corresponding to the second transmission configuration indicator state.

4. The method of claim 1, wherein receiving the first signaling from the first transmission-reception point and the second signaling from the second transmission-reception point comprises:
receiving the first signaling from the first transmission-reception point via a first beam associated with a first beam index and the second signaling from the second transmission-reception point via a second beam associated with a second beam index.

5. The method of claim 4, wherein:
the first beam and the second beam correspond to a beam combination of a plurality of beam combinations for receiving signaling from a plurality transmission-reception points, and
the first receive timing difference between the first receive timing and the second receive timing corresponds to a maximum receive timing difference of a plurality of receive timing differences determined for the plurality of beam combinations.

6. The method of claim 4, wherein the first signaling and the second signaling comprise respective synchronization signal blocks.

7. The method of claim 1, wherein the first receive timing for the first signaling corresponds to a first time at which the first signaling is received at the UE and the second receive timing for the second signaling corresponds to a second time at which the second signaling is received at the UE.

8. The method of claim 1, wherein the first transmission-reception point and the second transmission-reception point are associated with a same timing advance group.

9. The method of claim 1, wherein the first transmission-reception point is associated with a first timing advance group and the second transmission-reception point is associated with a second timing advance group.

10. The method of claim 9, wherein the first receive timing for the first signaling is based at least in part on a downlink frame timing of the first timing advance group and the second receive timing for the second signaling is based at least in part on a downlink frame timing of the second timing advance group.

11. The method of claim 9, wherein the first receive timing is based at least in part on a slot timing of the first timing advance group and the second receive timing for the second signaling is based at least in part on a slot timing of the second timing advance group.

12. The method of claim 1, further comprising:
transmitting, to the network entity and based at least in part on the first receive timing difference between the first receive timing and the second receive timing exceeding the threshold, a third message indicating at least two candidate transmission-reception points, wherein a receive timing difference associated with signaling from the at least two candidate transmission-reception points is less than or equal to the threshold.

13. The method of claim 12, wherein:
the second message indicates for the UE to perform the wireless communications with the two transmission-reception points, and
the at least two candidate transmission-reception points comprise the two transmission-reception points.

14. The method of claim 12, wherein the at least two candidate transmission-reception points are indicated by at least two transmission configuration indicator state groups, at least two sets of synchronization signal block indices, at least two control resource set pool indices, at least two physical cell identifiers, or any combination thereof.

15. The method of claim 1, wherein the second message indicates for the UE to perform wireless communications with the single transmission-reception point.

16. The method of claim 1, wherein the first message is transmitted in accordance with a periodicity or based at least in part on determining that the first receive timing difference between the first receive timing and the second receive timing exceeds the threshold.

17. The method of claim 1, wherein the first message comprises uplink control information, a medium access control-control element, or a radio link control message.

18. The method of claim 1, wherein the threshold is based at least in part on a subcarrier spacing or a radio frequency band configured for the UE.

19. A method for wireless communication at a network entity, comprising:
obtaining a first message indicating that a first receive timing difference at a user equipment (UE) between a first receive timing for first signaling from a first transmission-reception point associated with the network entity and a second receive timing for second signaling from a second transmission-reception point associated with the network entity exceeds a threshold; and
outputting a second message indicating for the UE to perform wireless communications with a single transmission-reception point or with two transmission-reception points associated with a second receive timing difference at the UE that is less than or equal to the threshold.

20. The method of claim 19, further comprising:
outputting a transmission configuration message indicating a plurality of transmission configuration indicator states, wherein the first transmission-reception point is associated with a first transmission configuration indicator state of the plurality of transmission configuration indicator states and the second transmission-reception point is associated with a second transmission configuration indicator state of the plurality of transmission configuration indicator states.

21. The method of claim 20, wherein the first receive timing corresponds to a first time at which the first signaling is received at the UE from the first transmission-reception point and the second receive timing corresponds to a second time at which the second signaling is received at the UE from the second transmission-reception point.

22. The method of claim 19, wherein the first transmission-reception point and the second transmission-reception point are associated with a same timing advance group.

23. The method of claim 19, wherein the first transmission-reception point is associated with a first timing advance group and the second transmission-reception point is associated with a second timing advance group.

24. The method of claim 19, further comprising:
obtaining a third message indicating at least two candidate transmission-reception points, wherein a receive timing difference associated with signaling from the at least two candidate transmission-reception points is less than or equal to the threshold, and wherein outputting the second message is based at least in part on obtaining the third message.

25. An apparatus for wireless communication, comprising:
memory;
a transceiver; and
at least one processor of a user equipment (UE), the at least one processor coupled with the memory and the transceiver, and the at least one processor configured to:
receive, via the transceiver, first signaling from a first transmission-reception point and second signaling from a second transmission-reception point, the first transmission-reception point and the second transmission-reception point both associated with a network entity;
determine that a first receive timing difference between a first receive timing for the first signaling from the first transmission-reception point and a second receive timing for the second signaling from the second transmission-reception point exceeds a threshold;
transmit, to the network entity via the transceiver and based at least in part on the determining, a first message indicating that the first receive timing difference between the first receive timing and the second receive timing exceeds the threshold; and
receive, from the network entity and in response to the first message, a second message indicating for the UE to perform wireless communications with a single transmission-reception point or with two transmission-reception points associated with a second receive timing difference at the UE that is less than or equal to the threshold.

26. The apparatus of claim 25, the at least one processor further configured to:
receive, from the network entity via the transceiver, a transmission configuration message indicating a first transmission configuration indicator state and a second transmission configuration indicator state, wherein the first transmission-reception point is associated with the first transmission configuration indicator state and the second transmission-reception point is associated with the second transmission configuration indicator state, and wherein receiving the first signaling from the first transmission-reception point and the second signaling from the second transmission-reception point is based at least in part on the transmission configuration message.

27. The apparatus of claim 25, wherein, to receive the first signaling from the first transmission-reception point and the second signaling from the second transmission-reception point, the at least one processor is configured to:
receive the first signaling from the first transmission-reception point via a first beam associated with a first beam index and the second signaling from the second transmission-reception point via a second beam associated with a second beam index.

28. The apparatus of claim 25, the at least one processor further configured to:
transmit, to the network entity and based at least in part on the first receive timing difference between the first receive timing and the second receive timing exceeding the threshold, a third message indicating at least two candidate transmission-reception points, wherein a receive timing difference associated with signaling from the at least two candidate transmission-reception points is less than or equal to the threshold.

29. The apparatus of claim 25, wherein the second message indicates for the UE to perform wireless communications with the single transmission-reception point.

30. An apparatus for wireless communication, comprising:
memory; and
at least one processor of a network entity, the at least one processor coupled with the memory, and the at least one processor configured to:
obtain a first message indicating that a first receive timing difference at a user equipment (UE) between a first receive timing for first signaling from a first transmission-reception point associated with the network entity and a second receive timing for second signaling from a second transmission-reception point associated with the network entity exceeds a threshold; and
output a second message indicating for the UE to perform wireless communications with a single transmission-reception point or with two transmission-reception points associated with a second receive timing difference at the UE that is less than or equal to the threshold.
